(19) United States
(12) Patent Application Publication
(10) Pub. No.: US 2026/0279335 A1
(43) Pub. Date: Sep. 17, 2026

(54) SYSTEM

(71) Applicant: SoftBank Group Corp., Tokyo (JP)

(72) Inventor: Tadashi ABE, Tokyo (JP)

(73) Assignee: SoftBank Group Corp., Tokyo (JP)

(21) Appl. No.: 19/550,343

(22) Filed: Feb. 26, 2026

Related U.S. Application Data
(60) Provisional application No. 63/771,265, filed on Mar. 13, 2025.

(51) Int. Cl. G10L 13/10; G10L 13/027; G10L 13/033; G10L 15/02; G10L 15/07; G10L 15/16; G10L 15/183; G10L 21/0232; G10L 21/034; G10L 21/0364; G10L 25/18; G10L 25/63

(52) U.S. Cl. CPC G10L 13/10; G10L 13/027; G10L 13/033; G10L 15/02; G10L 15/07; G10L 15/16; G10L 15/183; G10L 21/0232; G10L 21/034; G10L 21/0364; G10L 25/18; G10L 25/63; G10L 2013/105

(57) ABSTRACT

A system includes a processor that is configured to capture, in real time, uttered speech of a user by controlling a high-sensitivity microphone unit, perform digital signal processing on audio data captured by the high-sensitivity microphone unit by controlling a digital signal processing unit, analyze digitally processed audio data and convert the digitally processed audio data into a normal pronunciation by controlling an AI speech recognition unit, synthesize converted audio data into natural and fluent speech by controlling a speech synthesis unit, output synthesized speech by controlling a speaker unit, and communicate with an external device by controlling a wireless communication unit.

### CROSS-REFERENCE TO RELATED APPLICATION

This application claims the benefit of U.S. Provisional Application No. 63/771,265, filed on Mar. 13, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Many hearing-impaired users have difficulty producing speech that can be easily understood by other people in real time, even when they attempt to vocalize words. Conventional assistive systems for the hearing-impaired typically rely on text input, visual displays, or generic speech recognition that is not adapted to the user's specific articulation patterns, and therefore do not provide a natural spoken output that can seamlessly integrate into everyday verbal communication. In addition, known systems often lack integrated processing that captures the user's utterance in real time, performs adequate noise reduction and speech enhancement, converts the utterance into a normal pronunciation with high accuracy, and outputs synthesized speech that sounds natural and fluent. As a result, the user's participation in conversations in various environments such as workplaces, public spaces, and social gatherings remains limited, and the communication burden on both the user and surrounding people is high. Therefore, there is a need for a system that can, in real time, capture an uttered speech of a hearing-impaired user, adaptively recognize and convert the utterance into a normal pronunciation, and output a natural and fluent synthesized voice, while reducing environmental noise and supporting user-specific customization of speech recognition.

### SUMMARY

In order to solve at least part of the above-described problems, the present invention provides a system comprising a processor, wherein the processor is configured to capture, in real time, uttered speech of a user by controlling a high-sensitivity microphone unit, to perform digital signal processing on audio data captured by the high-sensitivity microphone unit by controlling a digital signal processing unit, to analyze digitally processed audio data and convert the digitally processed audio data into a normal pronunciation by controlling an AI speech recognition unit, to synthesize converted audio data into natural and fluent speech by controlling a speech synthesis unit, to output synthesized speech by controlling a speaker unit, and to communicate with an external device by controlling a wireless communication unit. The processor may be further configured to cause the digital signal processing unit to perform noise reduction to remove environmental sounds and background noise and to emphasize features of the user's uttered speech, thereby enhancing the clarity of the input signal. The processor may also be configured to cause the AI speech recognition unit to use a machine learning algorithm based on deep learning to customize processing in accordance with speech characteristics of the user and to train a model based on previously collected speech data of the user so as to estimate content of the uttered speech with high accuracy. By integrating real-time capture, user-specific AI speech recognition, digital signal processing including noise reduction, and natural speech synthesis in a single system, the invention enables a hearing-impaired user to have his or her uttered speech converted into a normal, natural-sounding spoken output that can be readily understood in various communication scenarios.

The term “system” refers to an arrangement of hardware and software components that cooperate to perform processing related to capturing, processing, recognizing, synthesizing, and outputting speech based on user utterances.

The term “processor” refers to one or more processing circuits, such as a CPU, GPU, DSP, microcontroller, or a combination thereof, that execute instructions to control and coordinate operations of various units in the system, including capturing audio, performing signal processing, recognizing speech, and synthesizing voice.

The term “high-sensitivity microphone unit” refers to a microphone or a set of microphones, together with associated circuitry, that are capable of detecting low-level sound signals from a user's uttered speech in real time, with sufficient sensitivity and directivity to capture subtle articulation while suppressing surrounding noise as much as possible.

The term “digital signal processing unit” refers to hardware, software, or a combination thereof that processes audio data in digital form, including operations such as noise reduction, filtering, dynamic range control, frequency emphasis, and other transformations intended to enhance the clarity and quality of the captured speech signal.

The term “audio data” refers to digital information representing sound, such as sampled and quantized waveform data or encoded audio frames, derived from the output of the high-sensitivity microphone unit.

The term “AI speech recognition unit” refers to a functional block implemented by hardware, software, or a combination thereof that uses artificial intelligence techniques, including machine learning or deep learning algorithms, to analyze digitally processed audio data and to convert the audio data into text or another representation corresponding to a normal pronunciation.

The term “machine learning algorithm based on deep learning” refers to a computational model, such as a neural network having multiple layers, that is trained on example data to learn complex mappings between input audio features and corresponding textual or phonetic outputs, and that is capable of adapting to user-specific speech characteristics.

The term “user-specific customization” refers to an operation in which parameters of a speech recognition model, such as acoustic model weights, speaker embeddings, or language model preferences, are adjusted based on speech data or profile information of a particular user so that the recognition accuracy for that user is improved.

The term “training a model based on previously collected speech data of the user” refers to a process in which a speech recognition model is updated, fine-tuned, or adapted using audio samples and corresponding labels obtained from utterances of the specific user, so that the model learns patterns characteristic of that user's articulation.

The term “normal pronunciation” refers to a standardized or commonly intelligible form of spoken language that can be readily understood by typical listeners, regardless of irregularities or distortions present in the original utterance of the user.

The term “speech synthesis unit” refers to hardware, software, or a combination thereof that converts textual or phonetic representations of speech into audio data corresponding to a human-like voice, for example by using a text-to-speech engine or a neural speech synthesis model.

The term “natural and fluent speech” refers to synthesized speech that exhibits human-like characteristics including appropriate prosody, intonation, rhythm, and smoothness, such that the resulting audio sounds like a normal human speaker and is comfortable for listeners to understand.

The term “speaker unit” refers to one or more loudspeakers and associated driving circuitry that convert synthesized audio data into audible sound waves, so that surrounding persons can hear the output speech.

The term “wireless communication unit” refers to a module that enables data exchange between the system and an external device over a wireless communication protocol, such as Bluetooth, Wi-Fi, cellular communication, or another radio-based interface, potentially including encryption and error-control functionality.

The term “external device” refers to a device separate from the main system, such as a smartphone, tablet, computer, or cloud server, that can exchange data with the system via the wireless communication unit for purposes including configuration, data storage, or further processing.

The term “real time” refers to processing and communication that occur with a latency sufficiently low that a user and surrounding persons can conduct a conversation without perceiving substantial delay between the user's utterance and the corresponding synthesized speech output.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

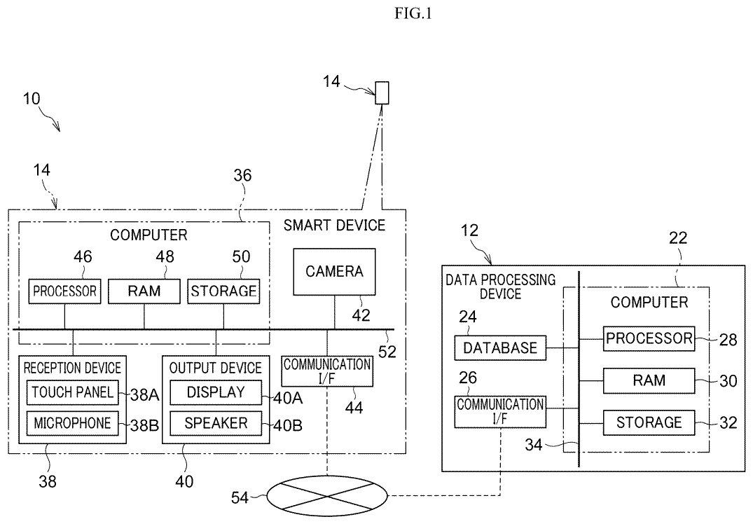

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

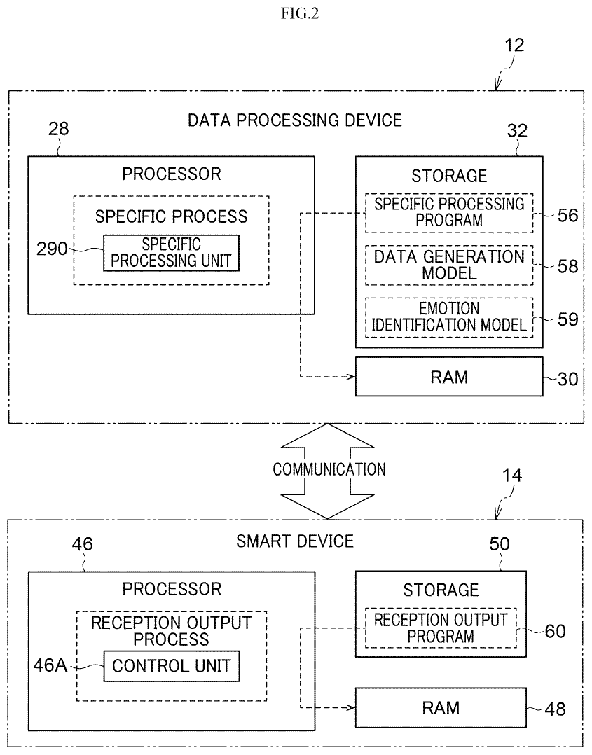

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for assisting hearing-impaired users in converting unclear utterances into normal speech often rely on generic speech recognition and speech synthesis pipelines that are not sufficiently adapted to atypical articulation patterns, non-standard prosody, or highly noisy environments. Such systems typically employ fixed noise reduction algorithms and generic acoustic and language models that are optimized for average speakers, and do not effectively exploit user-specific utterance history or frequent expressions. As a result, recognition accuracy degrades significantly for users whose pronunciation deviates from the training population, which leads to frequent recognition errors and unnatural synthesized speech output.

Moreover, known systems generally treat the speech recognition model and the speech synthesis model as static components that must be manually tuned and redeployed by experts. There is no flexible mechanism to automatically refine model adaptation policies or prosody control parameters based on continuously observed usage patterns, recognition error histories, or changes in the acoustic environment. This lack of adaptive control results in suboptimal use of computing resources, increased latency due to excessive or ill-targeted processing, and an inability to maintain consistent performance across diverse real-world contexts.

In addition, existing approaches do not take advantage of modern generative artificial intelligence models as meta-optimizers that can reason over multi-modal usage logs and meta-information to propose configuration updates or adaptation strategies. Without an automated mechanism to query a generative AI model using structured prompt sentences that encode user-specific meta-information, operators must manually analyze complex error patterns and system behaviors, which is time-consuming, error-prone, and not scalable.

Accordingly, there is a need for an improved computer-implemented system and method that: (i) acquires user utterances and applies enhanced digital signal processing to emphasize speech features under varying noise conditions; (ii) performs user-adapted speech recognition that incorporates utterance history and frequent expression information to correct and replace low-confidence segments; (iii) generates prosody-controlled synthesized speech according to user-specific voice output attributes; and (iv) uses a generative AI model, driven by prompt sentences including meta-information about user speech characteristics, usage environments, and error histories, to automatically refine configuration information such as adaptation policies and prosody control parameters. Such a system should improve the functioning of the underlying computer technology by enabling more accurate, robust, and efficient processing of atypical speech in real time, with reduced manual tuning and better utilization of computational and communication resources.

The specific processing by the specific processing unit 290 of the data processing device 12 in Example 1 is realized by the following means.

The present invention provides a server comprising a processor configured to acquire, via a communication interface, acoustic signals corresponding to user utterances from a terminal device, perform digital signal processing including noise suppression processing, frequency characteristic enhancement processing, and dynamic range correction processing on the acoustic signals to generate processed speech signals in which features of the user utterances are emphasized, convert the processed speech signals into time-series feature data, execute speech recognition processing using a deep learning model based on the time-series feature data to generate character strings representing contents of the user utterances, correct the character strings and perform phrase replacement based on utterance history information and frequent-expression information associated with a user, generate prosody control information including prosodic information for the corrected character strings, execute speech synthesis processing based on the prosody control information and voice output attributes set for the user to generate synthesized speech signals, transmit the synthesized speech signals to the terminal device for acoustic output, generate prompt sentences including meta-information relating to at least speech characteristics of the user, usage environments, and recognition error histories, transmit inquiry information including the prompt sentences to a generative information processing model, receive response information from the generative information processing model, and update configuration information relating to at least an adaptation method of the speech recognition processing and prosody control parameters of the speech synthesis processing based on the response information. This enables improvement of the operation of the computer-implemented speech conversion pipeline by dynamically adapting signal processing, recognition models, and synthesis control to individual users and environments, thereby enhancing recognition accuracy and naturalness of synthesized speech for atypical utterances while reducing manual tuning and improving efficiency of computational and communication resources.

The term “acoustic sensor unit” refers to a hardware arrangement including at least one sound transducer configured to convert sound pressure into an electrical signal, such as a microphone or equivalent sound-capturing device, for acquiring an acoustic signal corresponding to a user utterance in real time.

The term “acoustic signal” refers to an electrical or digital representation of sound, including analog waveforms and digitized samples, that corresponds to pressure variations generated by a user utterance.

The term “signal processing” refers to a sequence of computational operations performed on an acoustic signal, including but not limited to filtering, transforming, and modifying the signal in a time domain or frequency domain, in order to improve intelligibility, reduce noise, or extract features.

The term “noise suppression processing” refers to a category of signal processing operations configured to reduce or remove unwanted components such as environmental noise or background noise from an acoustic signal, for example by estimating noise characteristics and attenuating corresponding spectral components.

The term “frequency characteristic enhancement processing” refers to an operation that modifies the spectral distribution of an acoustic signal, for example by emphasizing or attenuating specific frequency bands, in order to enhance intelligibility or highlight features of a user utterance.

The term “dynamic range correction processing” refers to an operation that adjusts a level distribution of an acoustic signal, such as dynamic range compression or expansion, in order to control variations in loudness and improve audibility without introducing excessive distortion.

The term “processed speech signal” refers to a speech-related signal obtained as a result of applying one or more signal processing operations to an original acoustic signal, such that features of the user utterance are enhanced relative to noise or distortion. The term “time-series feature data” refers to a sequence of feature vectors derived from a speech signal over time, such as spectral coefficients or other numerical descriptors, which represent temporal evolution of acoustic characteristics suitable as input to a learning model.

The term “deep learning model” refers to a machine learning model including multiple layers of computational units, such as neural network layers, configured to learn complex mappings from time-series feature data to symbolic representations, and used for at least speech recognition processing in the system.

The term “speech recognition processing” refers to a computational procedure that converts time-series feature data derived from an acoustic signal into a symbolic representation, such as characters, phonetic units, or word tokens, that represent content of a user utterance.

The term “adapted for each user” refers to a configuration in which parameters, rules, or models used for speech recognition processing are adjusted based on data associated with a particular user, including utterance history or pronunciation characteristics, such that processing is specialized for that user.

The term “character string” refers to an ordered sequence of symbols, such as alphanumeric characters or other textual units, representing recognized linguistic content corresponding to a user utterance.

The term “utterance history information” refers to stored data associating past user utterances with corresponding recognition results, corrections, or context, used to refine or adjust subsequent processing for that user.

The term “frequent-expression information” refers to data identifying expressions, phrases, or word sequences that occur repeatedly in a user's communication, together with associated usage patterns or priorities, used to assist correction or replacement of recognized text.

The term “phrase replacement” refers to a process of partially or wholly substituting a portion of a recognized character string with an alternative expression, for example a stored frequent expression, based on criteria such as confidence scores, context, or user preferences.

The term “prosody control information” refers to data specifying prosodic attributes such as pitch contour, duration, rhythm, intonation, and stress patterns to be applied during speech synthesis processing for a given character string.

The term “prosodic information” refers to aspects of speech related to suprasegmental features, including but not limited to pitch, loudness, timing, and rhythm, which influence perceived naturalness and expressiveness of synthesized speech.

The term “voice output attributes” refers to parameters defining characteristics of synthesized speech for a user, including at least one of speaking rate, pitch, timbre, volume, language, or style, which are applied during speech synthesis processing.

The term “speech synthesis processing” refers to a computational procedure that generates a speech signal from text or symbolic input, using prosody control information and voice output attributes, to produce synthesized speech that is output as an audio waveform.

The term “synthesized speech signal” refers to a speech-related audio signal generated by speech synthesis processing, which is suitable for presentation to a listener via an acoustic output apparatus.

The term “acoustic output apparatus” refers to a device or combination of devices, such as a loudspeaker, earphone, or equivalent transducer, configured to convert a synthesized speech signal into sound waves perceivable by a listener.

The term “generative information processing model” refers to an information processing model, such as a generative artificial intelligence model, configured to generate output information including text or configuration data in response to input data, such as a prompt sentence, based on learned statistical relationships.

The term “prompt sentence” refers to a structured text input that describes a task, context, or requirement, and is provided to a generative information processing model to obtain a response useful for configuration, adaptation, or improvement of system components.

The term “inquiry information” refers to data transmitted to a generative information processing model, including at least one prompt sentence and optionally meta-information, for the purpose of obtaining response information that guides system configuration or adaptation.

The term “response information” refers to data output by a generative information processing model in response to inquiry information, including recommendations, configuration values, or procedural descriptions used to modify system behavior.

The term “configuration information” refers to stored information specifying operational parameters, adaptation policies, or control rules used by at least one component of the system, including speech recognition processing and speech synthesis processing.

The term “adaptation method of the speech recognition processing” refers to a procedure or rule set by which parameters or structures of a speech recognition model are modified or selected based on user-specific data, environment conditions, or error histories.

The term “prosody control parameters” refers to quantitative or categorical values, such as pitch range, speaking rate, or emphasis patterns, used by a speech synthesis component to implement prosody control information during generation of synthesized speech.

The term “wireless transmission path” refers to a communication channel based on wireless technology, such as radio-based communication, used to transmit and receive data including acoustic signals and synthesized speech signals between devices in the system.

The term “environmental condition of the user” refers to circumstances under which the user operates the system, including at least an acoustic environment, such as noise level or reverberation, and may further include location, motion state, or surrounding devices.

The term “communication state” refers to a status of a communication link between system components, including parameters such as available bandwidth, latency, error rate, or connection stability, which influence how data is transmitted and received.

In one embodiment, the system is implemented by cooperation between a terminal worn by a user and a server connected via a wireless communication network. The user wears the terminal, which includes at least an acoustic sensor unit, a signal processing circuit, a wireless communication interface, and an acoustic output apparatus. The server includes at least a processor, a memory, a storage apparatus, and a communication interface, and executes software modules for speech recognition, speech synthesis, user-specific adaptation, and interaction with a generative AI model.

The terminal acquires, in real time, an acoustic signal corresponding to a user utterance by using the acoustic sensor unit. The terminal uses, for example, a directional MEMS microphone element and an analog-to-digital converter (ADC) integrated in a microcontroller or an audio system-on-chip. The terminal converts the analog audio waveform to digital pulse code modulation (PCM) samples, and stores the PCM samples in a ring buffer in a random access memory. The terminal configures the sampling rate (for example, 16 kHz) and bit depth (for example, 16 bits) to balance latency and recognition accuracy. Because the acoustic sensor unit is physically positioned near the user's mouth, the terminal acquires a higher signal-to-noise ratio than a handheld device, which improves later digital processing.

The terminal performs digital signal processing on the PCM samples by using a digital signal processor or a general-purpose processor executing a signal processing routine. The terminal performs short-time Fourier transform (STFT) on windowed frames and estimates a noise spectrum from frames classified as non-speech by a voice activity detector. The terminal then performs noise suppression by subtracting or attenuating the estimated noise spectrum from the magnitude spectrum of each frame and reconstructing a time-domain waveform. The terminal further performs frequency characteristic enhancement by applying, for example, a cascaded set of biquad filters that emphasize a frequency band corresponding to human speech intelligibility. The terminal also performs dynamic range correction by computing a running estimate of frame energy and applying gain curves that compress large variations in level. This specific combination of spectral subtraction, band emphasis, and dynamic range compression improves intelligibility and robustness of the signal provided to the server, thereby reducing the computational burden on server-side recognition models and allowing the server to use smaller, more efficient models without loss of accuracy.

The terminal encodes the processed speech signal using a frame-based audio codec, such as a code-excited linear prediction codec or a low-latency transform codec, and transmits the encoded frames to the server through the wireless communication interface. The terminal forms packets including sequence numbers and timestamps, and transmits the packets over a wireless transmission path, such as a wireless local area network or a short-range wireless link. The terminal encrypts packet payloads by using a session key derived from an authentication procedure. By performing encoding and packetization at the terminal, the system reduces the amount of data transmitted over the network and decreases latency, which is a technical improvement over simple raw audio streaming.

The server receives the encoded frames by using the communication interface and stores the frames into an input buffer in the memory. The server decodes the frames to reconstruct the processed speech signal. The server then converts the processed speech signal into time-series feature data by executing a feature extraction module. The server first applies an STFT to overlapping frames and computes a magnitude spectrogram. The server then multiplies the spectrogram by a set of mel filter banks to generate mel-frequency filter bank energies. The server applies a logarithmic transform and, optionally, a discrete cosine transform to obtain cepstral coefficients. The server normalizes the feature vectors with respect to per-user statistics maintained in a data store, such as mean and variance for each coefficient. This normalization compensates for user-specific loudness and spectral biases and stabilizes the input distribution of the recognition model, which improves convergence behavior and recognition accuracy.

The server performs speech recognition processing by using a deep learning model stored in the memory and loaded into a hardware accelerator, such as a graphics processor or a specialized neural accelerator. In one embodiment, the server uses an encoder-decoder architecture with attention, or a convolution-augmented transformer (Conformer) architecture. The server configures the encoder as a stack of layers, each including multi-head self-attention, depthwise separable convolution, and feed-forward blocks. The server applies positional encoding to the input feature sequence so that the model can represent temporal relationships. The server trains the model using a loss function such as connectionist temporal classification loss or cross-entropy loss on subword units. During inference, the server executes a decoding algorithm, such as beam search with a language model, to output a sequence of tokens. The server then maps the tokens to characters to obtain a character string representing the content of the user utterance.

The server adapts the speech recognition model for each user by using utterance history information and frequent-expression information stored in the storage apparatus. The server maintains, for each user, a data structure that includes past utterance feature sequences, recognition results, corrections, and a list of frequently used phrases. The server adjusts decoding behavior by increasing scores for tokens corresponding to frequent expressions and by applying user-specific pronunciation mappings derived from previously observed pronunciations. In another embodiment, the server maintains adapter layers or fine-tuning parameters that are specific to each user and that are updated in response to new labeled data. The server updates these parameters by computing gradients of the loss function with respect to user-specific weights and applying a weight update rule, such as stochastic gradient descent or an adaptive optimizer. Because the server stores and applies user-specific parameters separately from a shared base model, the system can efficiently personalize recognition without retraining the entire model, thereby improving computational efficiency and enabling real-time adaptation.

The server performs correction and phrase replacement on the recognized character string. The server computes a confidence score for each token or word based on output probabilities from the deep learning model and language model scores. The server compares subsequences of the character string to frequent-expression information stored for the user and identifies candidate replacements whose edit distance falls below a threshold and whose use frequency exceeds a threshold. When a subsequence has low confidence and matches a frequent expression candidate, the server replaces the subsequence with the stored expression. This non-conventional combination of token-level confidence, edit distance comparison, and user-specific frequency thresholds reduces recognition errors in phrases that are important to the user, such as common greetings or work-specific terminology, and improves overall perceived accuracy without increasing model complexity.

The server generates prosody control information for the corrected character string. The server first converts the character string into a sequence of linguistic units, such as phonemes or syllables, and annotates the sequence with part-of-speech tags, punctuation, and phrase boundaries by using a linguistic analysis module. The server then uses a prosody prediction model, which may be a neural network with recurrent, convolutional, or transformer layers, to predict for each unit a pitch contour, duration, and emphasis pattern. The server parameterizes the prosody control information as time-aligned vectors or as a sequence of control tags. By explicitly computing prosody control information separate from waveform generation, the server can impose user-specific constraints, such as slower speaking rate or reduced pitch variation, by scaling or offsetting the prosody parameters before synthesis.

The server performs speech synthesis processing to generate a synthesized speech signal based on the prosody control information and voice output attributes set for the user. In one embodiment, the server uses a sequence-to-sequence acoustic model (such as an encoder-decoder with attention) that converts phoneme sequences and prosody control vectors into mel-spectrograms, and a neural vocoder model (such as an autoregressive waveform model or a fully convolutional model) that converts mel-spectrograms into time-domain waveforms. The server configures the acoustic model to accept prosody control information as an additional input channel or conditioning vector. During inference, the server modifies control parameters according to the user's voice output attributes, such as speaking rate scaling, global pitch shift, or timbre selection, and feeds the adjusted parameters into the model. This architecture enables fine-grained control of synthesized speech properties at runtime without retraining the model, which is a technical improvement over conventional fixed-prosody synthesizers.

The server transmits the synthesized speech signal to the terminal through the communication interface. The server may encode the synthesized speech signal using a low-latency codec and packetize the encoded frames with timestamps. The terminal receives the packets, decodes the frames, and outputs the synthesized speech signal through the acoustic output apparatus. The terminal may apply final equalization and dynamic range processing optimized for the hardware characteristics of the speaker. As a result, the user's unclear utterance is converted into clear, natural-sounding speech, and other persons in the environment can understand the content without needing to interpret the user's articulation directly.

The server interacts with a generative AI model by using prompt sentences to improve configuration information used in the speech recognition and speech synthesis processing. The server stores, for each user and for the system as a whole, meta-information including user speech characteristics, usage environments, and recognition error histories. The server forms a prompt sentence by combining this meta-information into a structured natural language request. For example, the server generates a prompt sentence such as:

“List the hardware and software components required to design a system that converts utterances of hearing-impaired users into normal speech, and explain in detail how each component functions, including its role in noise reduction, speech recognition, and speech synthesis.”

In another example, the server generates a prompt sentence such as:

“In a system that combines speech recognition and speech synthesis, describe concrete methods for customizing the recognition model according to a user's articulation characteristics, including data collection, model fine-tuning procedures, and evaluation metrics.”

In a further example relating to error handling, the server generates a prompt sentence such as:

“Design a robust error-handling flow for a system that streams audio from a wearable terminal to a server for recognition and synthesis. Include strategies for packet loss, network latency, and temporary server failure.”

The server transmits inquiry information including the prompt sentence to the generative AI model via an application programming interface. The server receives response information and parses it into structured configuration items, such as recommended adaptation learning rates, thresholds for phrase replacement, or prosody control parameter ranges. The server then updates configuration information stored in the storage apparatus, including adaptation policies for the speech recognition model and prosody control parameters for the speech synthesis model. Because the generative AI model performs reasoning over aggregated system behavior and proposes non-trivial configuration updates, the server uses a computational process that is not equivalent to simple human manual tuning. The server repeatedly applies this process over time, which results in continuous improvement of the computer-implemented pipeline without requiring complete retraining of models or manual redesign of rules.

The server thereby improves the functioning of the underlying computer system in several ways. First, user-specific adaptation using structured history data and frequent-expression replacement reduces recognition errors and allows the server to use more compact models with equal or higher accuracy compared to generic models, which reduces memory and compute requirements. Second, terminal-side preprocessing reduces network bandwidth and latency, enabling real-time communication even over limited wireless channels. Third, explicit prosody control information allows the server to decouple linguistic and acoustic processing, so that adjustments to prosody can be made without retraining the entire speech synthesis model, improving maintainability and flexibility. Fourth, the interaction with the generative AI model through prompt sentences provides a mechanism for automatically refining technical configuration parameters based on operational data, which would be impractical to compute manually. As a result, the system as a whole achieves improved speed, accuracy, and robustness in processing atypical speech, and these improvements are rooted in specific data structures, algorithms, and hardware cooperation rather than in abstract automation of a human mental process.

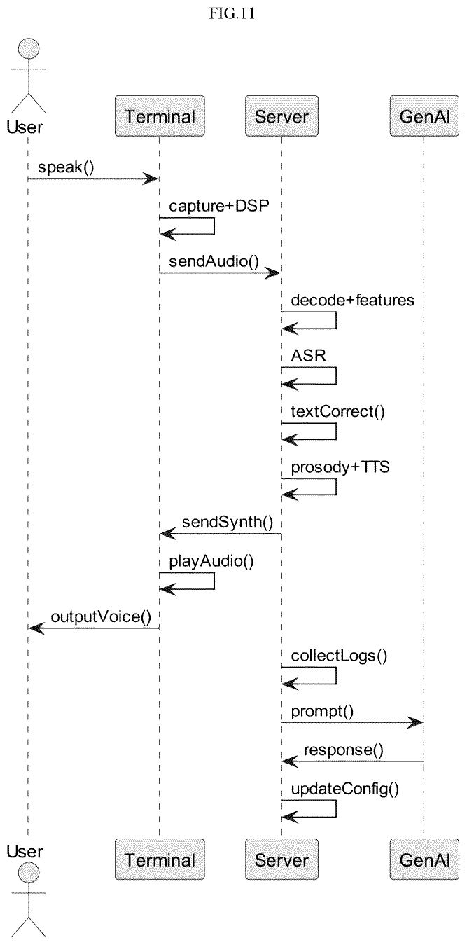

The user may operate the system through a terminal-linked application to set voice output attributes, to register frequent expressions, and to control whether utterance history data is used for adaptation. The server respects such user settings while continuing to execute the described technical processes. Alternative embodiments may replace specific neural network architectures with other architectures, such as recurrent neural networks with attention or fully convolutional temporal networks, or may use different feature types, such as raw waveform inputs with learnable front-end layers, while preserving the overall structure of user-adaptive recognition, prosody-controlled synthesis, and configuration refinement through a generative AI model. In each case, the server and the terminal cooperate to perform concrete computational operations on audio data and configuration data, thereby implementing the claimed invention in a manner that can be practiced by persons skilled in the art. The following describes the processing flow using FIG. 11.

### Step 1:

The user wears the terminal and starts speaking, and the terminal acquires an analog acoustic signal as input from an acoustic sensor unit positioned near the user's mouth. The terminal uses a microphone and an analog-to-digital converter to convert the analog waveform into digital pulse code modulation (PCM) samples as output, while configuring a sampling rate and bit depth suitable for subsequent processing.

### Step 2:

The terminal receives, as input, the PCM samples stored in a ring buffer and performs digital signal processing operations to generate a noise-suppressed, intelligibility-enhanced speech signal as output. The terminal segments the PCM stream into overlapping frames, applies a window function, executes a short-time Fourier transform on each frame, estimates a noise spectrum from non-speech frames, subtracts or attenuates the estimated noise components in the frequency domain, applies band-emphasis filtering to boost speech-relevant frequencies, and performs dynamic range compression to reduce large amplitude variations before reconstructing the time-domain signal.

### Step 3:

The terminal receives, as input, the processed speech signal and encodes it into a compressed bitstream as output suitable for wireless transmission. The terminal divides the processed signal into codec frames, applies an audio codec algorithm to reduce data size while preserving intelligibility, attaches sequence numbers and timestamps to each encoded frame, and stores the resulting packets in a transmission buffer.

### Step 4:

The terminal transmits, as input to a communication channel, the encoded packets and produces, as output, encrypted wireless packets delivered toward the server. The terminal establishes a secure session, encrypts packet payloads with a session key, schedules packet transmission according to network conditions, retransmits missing packets when acknowledgments are not received, and thereby maintains a low-latency, loss-tolerant stream to the server.

### Step 5:

The server receives, as input, the encrypted packets from the terminal via a communication interface and reconstructs a continuous decoded speech signal as output. The server verifies integrity checks, decrypts the payloads, reorders packets based on sequence numbers, fills short gaps using packet loss concealment techniques, decodes the audio frames using a corresponding codec, and writes the resulting PCM samples into an input audio buffer.

### Step 6:

The server receives, as input, the reconstructed PCM samples and generates time-series feature data as output for speech recognition. The server segments the PCM samples into overlapping analysis frames, applies a window function, computes a magnitude spectrogram by executing a short-time Fourier transform, projects the spectrogram onto a set of mel filter banks, applies a logarithmic transform, optionally computes cepstral coefficients, and normalizes each feature dimension using stored per-user mean and variance values to produce normalized feature vectors in sequence.

### Step 7:

The server receives, as input, the sequence of normalized feature vectors and outputs a preliminary character string representing a recognized utterance. The server feeds the feature sequence into a deep learning speech recognition model, computes layer-by-layer transformations including attention, convolution, and nonlinear activation, obtains probability distributions over tokens at each time step, and executes a decoding algorithm, such as beam search with a language model, to select the most likely sequence of tokens and convert it into a text character string.

### Step 8:

The server receives, as input, the preliminary character string along with token-level confidence scores and user-specific history data, and generates a corrected character string as output. The server retrieves utterance history information and frequent-expression information for the user from storage, identifies low-confidence segments in the preliminary string, computes similarity measures between these segments and stored frequent expressions, and replaces segments with matching frequent expressions when similarity and frequency thresholds are satisfied, thereby producing a corrected text that better reflects the user's intended utterance.

### Step 9:

The server receives, as input, the corrected character string and produces prosody control information as output. The server tokenizes the text into linguistic units, assigns part-of-speech tags and phrase boundaries, and applies a prosody prediction model that uses the linguistic features and punctuation to compute, for each unit, target pitch contour, duration, and emphasis values, yielding a time-aligned sequence of prosodic parameters that will guide speech synthesis.

### Step 10:

The server receives, as input, the prosody control information and the corrected character string, together with stored voice output attributes for the user, and outputs a synthesized speech signal. The server converts the text to phoneme or grapheme sequences, feeds the sequences and prosody control vectors into a neural acoustic model to generate a mel-spectrogram, modifies prosody parameters according to user-specified speaking rate and pitch preferences, and then passes the mel-spectrogram to a neural vocoder that computes time-domain waveform samples as the synthesized speech signal.

### Step 11:

The server receives, as input, the synthesized speech signal and generates encoded output packets for the terminal. The server segments the synthesized waveform into frames, encodes each frame using an audio codec, attaches sequence numbers and timestamps, encrypts the payloads, and transmits the packets over the wireless channel to the terminal via the communication interface.

### Step 12:

The terminal receives, as input, the encrypted synthesized-audio packets and outputs an audio waveform suitable for playback on the acoustic output apparatus. The terminal decrypts each packet, reorders frames using sequence numbers, decodes the audio frames into PCM samples, writes the samples into an output buffer, and drives a digital-to-analog converter and power amplifier to generate sound through a speaker, optionally applying final equalization and volume control based on user settings and ambient noise level.

### Step 13:

The server receives, as input, recognition logs, prosody settings, and performance metrics accumulated over multiple utterances and generates meta-information as output for use with a generative AI model. The server aggregates data such as typical recognition errors, noise conditions, user speaking patterns, and system latency, compresses this data into a structured description, and encodes it as natural-language text fragments and parameter summaries.

### Step 14:

The server receives, as input, the meta-information and constructs a prompt sentence as output to query the generative AI model. The server formats the meta-information into a natural-language request that specifies the current problems or optimization goals, such as improving user-specific adaptation thresholds or prosody control ranges, for example: “In a system that combines speech recognition and speech synthesis, describe concrete methods for customizing the recognition model according to a user's articulation characteristics, including data collection, model fine-tuning procedures, and evaluation metrics.”

### Step 15:

The server sends, as input to the generative AI model, inquiry information including the prompt sentence and receives response information as output. The server transmits the prompt over an application programming interface, obtains a textual response that includes proposed configuration changes or algorithmic procedures, and stores the response for subsequent parsing.

### Step 16:

The server receives, as input, the response information from the generative AI model and outputs updated configuration information for internal modules. The server parses the textual response to extract specific numerical parameters, rule adjustments, or adaptation strategies, validates these against predefined safety and performance constraints, and writes approved values into configuration data structures controlling thresholds, learning rates, phrase replacement policies, and prosody ranges.

### Step 17:

The server receives, as input, the updated configuration information and adjusts internal processing behavior as output for future utterances. The server reloads or reinitializes parts of the speech recognition and speech synthesis pipelines, such as user-specific adaptation layers or prosody scaling factors, based on the new configuration, so that subsequent feature extraction, decoding, correction, and synthesis operations are carried out under refined parameters derived from the generative AI-assisted optimization.

### Step 18:

The user receives, as input, the synthesized speech output and provides implicit feedback as output through continued use patterns and correction actions. The user listens to the converted speech, observes whether colleagues or communication partners understand the message, and optionally corrects misrecognitions via a user interface; the server and terminal indirectly capture this behavior in logs and history data, which become input for later adaptation and prompt-generation steps.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional speech conversion systems for users with hearing or speech impairments suffer from several technical limitations in the underlying computer technology. First, typical client devices either stream raw or minimally processed audio to a server or perform only coarse noise suppression. As a result, server-side speech recognition algorithms are forced to handle acoustically degraded signals, which leads to reduced recognition accuracy, particularly in real-world environments such as care facilities, where background noise and overlapping conversations are common. This degrades the performance of the recognition models and leads to instability and latency in the end-to-end pipeline.

Second, existing systems often use generic speech recognition and speech synthesis models that are not sufficiently adapted to individual users. In particular, elderly users or users with articulation disorders may exhibit speaker-specific acoustic patterns and vocabularies that differ significantly from training data used for general-purpose models. Conventional systems typically maintain only static user profiles or simple dictionaries and do not implement a systematic mechanism in the computing architecture to accumulate user-specific data, derive adaptation parameters, and feed these parameters back into acoustic models, language models, or synthesis models. Consequently, recognition accuracy saturates or even deteriorates over time, and the generated speech may not be intelligible or comfortable for caregivers and family members.

Third, most systems lack an integrated mechanism to automatically leverage advances from generative artificial intelligence models within the system's computing pipeline. Even when such models are used manually by developers, the system does not include a processor-controlled mechanism to generate prompt sentences, send them to a generative AI model, receive structured responses, and automatically convert those responses into updated internal parameters, vocabularies, or text templates. This results in a rigid architecture that cannot flexibly incorporate new knowledge, better prompt designs, or improved adaptation strategies, and thus fails to fully utilize modern AI techniques to improve core computational components such as recognition and synthesis.

Fourth, the coordination between terminal devices and server-side processing is often rudimentary. Many systems transmit audio and receive synthesized speech without jointly optimizing the client-side signal enhancement, server-side feature extraction, model inference, and logging in a unified processing flow. The lack of such integration prevents effective management of care records and deprives the system of a feedback loop where logged interaction data improves the underlying computational models.

Accordingly, there is a need for an improved computer-implemented system and method that (i) performs advanced noise reduction and speech enhancement on the client side to supply high-quality audio to server-side models, (ii) maintains and applies user-specific adaptation parameters and vocabularies to both speech recognition and speech synthesis, (iii) programmatically integrates an external generative AI model via prompt sentences to refine internal models, dictionaries, and dialogue templates, and (iv) stores recognized text as structured records to drive continuous, data-driven improvement of the overall computational pipeline. Such a system should materially improve the functioning of the underlying computers and models by achieving higher accuracy, robustness, and adaptability in real-time speech conversion scenarios for impaired users.

The specific processing by the specific processing unit 290 of the data processing device 12 in Application Example 1 is realized by the following means.

The present invention provides a server comprising a processor and a memory storing instructions that, when executed by the processor, cause the processor to control an acoustic input unit of a terminal apparatus to acquire, in real time, a voice utterance of a user as an audio signal, to perform time-domain and frequency-domain analysis of the audio signal so as to estimate a noise component and to generate an enhanced audio signal by executing noise reduction and speech enhancement including spectral subtraction or filtering, to segment the enhanced audio signal into frames and extract an acoustic feature sequence, to convert the acoustic feature sequence into character string data by inputting the acoustic feature sequence to a deep-learning-based speech recognition model while updating a recognition result based on stored speaker characteristic information and vocabulary information for each user, to normalize the character string data and perform linguistic unit segmentation so as to generate a linguistic feature sequence for speech synthesis, to generate an audio waveform by inputting the linguistic feature sequence to a statistical or neural-network speech synthesis model while adjusting prosody, speaking rate, and pitch based on user preference information, to control an acoustic output unit of the terminal apparatus so as to reproduce the generated audio waveform with an output volume and a frequency characteristic adapted to an ambient sound level, to store the character string data and the speaker characteristic information in a storage medium as structured records, to derive and apply speaker adaptation parameters and vocabulary bias parameters to at least one of an acoustic model and a language model of the speech recognition model, and to transmit inquiry data including a prompt sentence related to customization of the speech recognition model or the speech synthesis model or related to creation of a dialogue template to an external generative artificial intelligence model and, based on response data received from the external generative artificial intelligence model, update at least one of the speaker characteristic information, the vocabulary information, and text template information used by the speech recognition model and the speech synthesis model. This enables improved computer performance in speech conversion processing by providing higher-quality input signals to machine-learning models, dynamically adapting acoustic and language models and synthesis parameters to user-specific characteristics and usage patterns, and programmatically leveraging generative artificial intelligence responses to refine internal model configurations and dialogue resources, thereby increasing recognition accuracy, synthesis naturalness, robustness to noise, and the overall efficiency and adaptability of the server-terminal speech processing architecture.

The term “system” refers to a combination of one or more hardware devices and software components that cooperate to perform speech acquisition, processing, recognition, synthesis, communication, storage, and adaptation functions as described in the claims.

The term “processor” refers to an electronic data processing component, such as a central processing unit, a microcontroller, or a dedicated signal processing unit, that executes stored instructions to perform arithmetic, logical, control, and input/output operations.

The term “memory” refers to a computer-readable storage medium, such as semiconductor memory, magnetic storage, or optical storage, that stores instructions and data for access and execution by the processor.

The term “instructions” refers to executable program code, firmware, or microcode that, when executed by the processor, causes the processor to perform specified operations.

The term “user” refers to a human individual whose voice utterances are acquired, processed, recognized, synthesized, or otherwise handled by the system.

The term “voice utterance” refers to an acoustic event generated by the user's speech, including words, phrases, sentences, or other vocal sounds intended for communication.

The term “audio signal” refers to an electrical or digital representation of sound, including sampled waveforms obtained from a microphone or audio input circuit.

The term “acoustic input unit” refers to a hardware and software combination that acquires a voice utterance as an audio signal, such as a microphone, an analog-to-digital converter, and associated driver software.

The term “real time” refers to processing that is performed with sufficiently low latency such that the output is generated substantially without perceptible delay relative to the user's utterance in typical conversational scenarios.

The term “time-domain analysis” refers to processing operations performed directly on the audio signal as a function of time, such as framing, windowing, amplitude analysis, or filtering in the time domain.

The term “frequency-domain analysis” refers to processing operations performed on a representation of the audio signal in the frequency domain, such as spectra or spectrograms obtained by Fourier transform or related methods.

The term “noise component” refers to an acoustic or electrical signal component that is not part of the desired speech signal, including background sounds, environmental noises, or other interference.

The term “noise reduction” refers to a signal processing operation that reduces the energy or perceptual impact of the noise component in the audio signal while preserving speech components as much as possible.

The term “speech enhancement” refers to processing operations that increase the intelligibility or quality of speech in an audio signal, including amplification of speech-dominant frequency bands and suppression of non-speech components.

The term “spectral subtraction” refers to a noise reduction method in which an estimate of a noise spectrum is subtracted from a noisy speech spectrum to obtain an enhanced speech spectrum.

The term “filtering” refers to an operation that selectively attenuates or amplifies certain frequency components of the audio signal, such as by using digital filters or frequency-domain gain functions.

The term “enhanced audio signal” refers to an audio signal that has undergone noise reduction and speech enhancement, and that exhibits improved speech quality and intelligibility compared to the original audio signal.

The term “frame” refers to a contiguous segment of an audio signal of a predetermined duration used as a basic unit for analysis or feature extraction.

The term “frame length” refers to the duration or sample count of each frame into which the audio signal is segmented for processing.

The term “shift length” refers to the temporal offset or sample count by which consecutive frames are advanced relative to each other in a frame-based processing scheme.

The term “acoustic feature sequence” refers to a time-ordered series of feature vectors derived from the audio signal, such as Mel-frequency cepstral coefficients or filterbank energies, used as input to a speech recognition model.

The term “speech recognition model” refers to a computational model, including an acoustic model and optionally a language model, that converts an acoustic feature sequence into a representation of linguistic content such as a character sequence or word sequence.

The term “deep-learning-based” refers to the use of a machine learning model having multiple layers of nonlinear processing units, such as neural networks, that learn patterns from data by optimization of parameters.

The term “character string data” refers to a sequence of symbols representing textual content, such as letters, characters, or subword units encoded in a specific character set.

The term “recognition result” refers to the textual or symbolic output produced by the speech recognition model that represents the system's estimate of the content of a user's utterance.

The term “speaker characteristic information” refers to stored data describing properties of an individual user's voice, such as acoustic statistics, adaptation parameters, or speaker embeddings used to tailor recognition or synthesis to that user.

The term “vocabulary information” refers to stored linguistic data relating to words, phrases, or subword units, including user-specific lexicons, frequency statistics, and biasing information used by recognition or synthesis components.

The term “normalize the character string data” refers to processing textual output to a standard form, including operations such as converting character variants, expanding abbreviations, standardizing numerical expressions, or applying orthographic conventions.

The term “linguistic unit segmentation” refers to the division of text into meaningful units such as sentences, clauses, phrases, syllables, or phonetic units for use in downstream processing like speech synthesis.

The term “linguistic feature sequence” refers to a sequence of symbolic or numerical representations derived from text, including phonetic symbols, prosodic labels, or part-of-speech tags, used as input to a speech synthesis model.

The term “speech synthesis model” refers to a computational model that converts a linguistic feature sequence into an audio waveform representing speech.

The term “statistical” refers to a modeling approach in which parameters are learned by probabilistic methods, such as hidden Markov models or parametric generative models.

The term “neural-network speech synthesis model” refers to a speech synthesis model implemented as a neural network that directly or indirectly predicts acoustic features or waveforms from linguistic or acoustic input.

The term “audio waveform” refers to a time-domain representation of sound pressure or voltage samples that can be rendered audible by a transducer such as a loudspeaker.

The term “prosody” refers to suprasegmental aspects of speech such as intonation, rhythm, stress, and timing that influence how speech sounds natural and expressive.

The term “speaking rate” refers to the temporal speed of speech production, such as the number of syllables or words produced per unit time.

The term “pitch” refers to the perceived fundamental frequency of a speech signal, which is related to the physical fundamental frequency of vocal fold vibration.

The term “preference information” refers to stored parameters associated with a user's desired characteristics of synthetic speech, including preferred speaking rate, pitch, voice type, and prosodic style.

The term “acoustic output unit” refers to a hardware and software combination that converts digital audio data into audible sound, such as a digital-to-analog converter, amplifier, and loudspeaker, controlled by appropriate drivers.

The term “ambient sound level” refers to a measure of background noise intensity in the environment, obtained for example by a microphone and level estimation algorithm.

The term “output volume” refers to the amplitude level at which the audio waveform is reproduced by the acoustic output unit.

The term “frequency characteristic” refers to the distribution of gain or attenuation across different frequencies during audio reproduction, such as implemented by equalization.

The term “terminal apparatus” refers to a user-side device that includes the acoustic input unit, the acoustic output unit, and communication functions, and that interacts with a remote information processing apparatus.

The term “information processing apparatus” refers to a device, such as a server or computing platform, that executes speech recognition, speech synthesis, data storage, and generative AI integration functions.

The term “communication unit” refers to hardware and software that perform data transmission and reception between the terminal apparatus and the information processing apparatus over a wired or wireless network.

The term “encrypted manner” refers to a transmission mode in which data is transformed using a cryptographic algorithm and keys, such that unauthorized parties cannot easily recover the original data.

The term “storage medium” refers to a physical medium, such as solid-state memory, magnetic disk, or optical disk, capable of storing digital data persistently or semi-persistently.

The term “structured records” refers to data stored in an organized format, such as database tables or documents with defined fields and metadata, enabling systematic retrieval and analysis.

The term “care record information” refers to structured records capturing communication content and related context about a user for use in care management, monitoring, or documentation.

The term “speaker adaptation parameters” refers to numerical parameters derived from user data that modify or augment a base model, such as an acoustic model, so that it better reflects the characteristics of a particular speaker.

The term “vocabulary bias parameters” refers to numerical or symbolic parameters that influence probability distributions over words or subword units, increasing the likelihood of user-specific or domain-relevant terms during recognition.

The term “acoustic model” refers to a component of a speech recognition model that maps acoustic features to basic linguistic units such as phonemes, characters, or subword units.

The term “language model” refers to a component that assigns probabilities to sequences of linguistic units, such as words or characters, and constrains or guides decoding in speech recognition.

The term “external generative artificial intelligence model” refers to a machine learning model, typically a large language model or similar generative model, that is operated outside the local system and that can generate text or other outputs in response to input prompts.

The term “inquiry data” refers to data transmitted to the external generative artificial intelligence model, including a prompt sentence and optional context information requesting a generated response.

The term “prompt sentence” refers to a textual input that instructs or guides the external generative artificial intelligence model to produce specific types of responses, such as customization strategies or dialogue templates.

The term “response data” refers to data generated by the external generative artificial intelligence model and returned to the system in response to the inquiry data.

The term “text template information” refers to predefined or generated text patterns, such as dialogue templates or phrase lists, used to support user interaction or to bias recognition and synthesis toward preferred expressions.

The term “update” refers to an operation that modifies stored data or parameters, including overwriting, augmenting, or adjusting values based on new information or computation results.

In one embodiment of the present invention, a system includes a terminal and a server that cooperate to acquire, process, recognize, synthesize, transmit, and log speech in a manner that improves the functioning of computer-based speech processing. The terminal includes an acoustic input unit, an acoustic output unit, a wireless communication unit, a local processor, and a memory. The server includes at least one processor, a memory, a network interface, a non-transitory storage medium, a speech recognition model, a speech synthesis model, and a generative AI interface module.

The terminal uses a high-sensitivity directional microphone as the acoustic input unit. The microphone can be implemented as a micro-electro-mechanical system microphone mounted on an ear-worn device or pendant-type device. The terminal couples the microphone to an analog-to-digital converter and to a local processor, for example a microcontroller or an application processor. The local processor may be implemented by a general-purpose processor core, such as a reduced instruction set processor, or by a digital signal processing core. The local processor executes firmware that performs voice activity detection, frame segmentation, noise estimation, noise reduction, and speech enhancement on digitized audio samples.

The terminal uses a digital signal processing library, such as a library implementing fast Fourier transform and inverse fast Fourier transform routines, to convert time-domain frames of audio into frequency-domain spectra and back. The terminal analyzes the spectra to estimate a noise spectrum during non-voice segments and stores this noise spectrum in memory as a noise profile. The terminal applies spectral subtraction or Wiener filtering by subtracting or attenuating the noise spectrum from the observed spectrum of a voice frame. The terminal then applies gain control in specific frequency bands characteristic of human speech, such as bands between approximately 300 Hz and 3400 Hz, to emphasize speech energy. The terminal finally applies an overlap-add procedure to reconstruct an enhanced audio signal in the time domain. Because the terminal performs these operations before transmission, the server receives an audio stream with reduced noise and more stable levels, which directly improves the numerical stability and accuracy of downstream feature extraction and model inference.

The terminal uses a wireless communication unit, for example a wireless transceiver supporting a local wireless protocol or a wireless local area network protocol, and a network stack implementing transmission control and security protocols. The terminal segments the enhanced audio signal into packets, attaches headers including a user identifier and timestamps, and encrypts the payload. The terminal transmits these packets to the server and manages retransmission and buffering so that the server receives a continuous, ordered audio stream.

The server receives the enhanced audio stream through its network interface and stores incoming audio in a buffer in main memory. The server uses a feature extraction module implemented in software, for example using a numerical computing library, to compute acoustic feature vectors from the enhanced audio frames. The server applies a pre-emphasis filter, windowing, and a short-time Fourier transform, and then computes Mel-frequency filterbank energies or Mel-frequency cepstral coefficients. The server normalizes these features based on speaker-specific statistics stored in a profile, such as mean and variance values for each feature dimension. This normalization produces feature vectors that have reduced variance and are centered, which improves the conditioning of the input to the speech recognition model and accelerates convergence of internal computations in the model.

The server uses a speech recognition model implemented as a deep neural network. In one embodiment, the speech recognition model includes an encoder portion that is composed of multiple layers of self-attention and feed-forward sublayers, and a decoder or output portion that generates a sequence of probability distributions over characters or subword units. In another embodiment, the speech recognition model includes a recurrent neural network with long short-term memory layers or gated recurrent units and a connectionist temporal classification output layer. The server stores model parameters, such as weight matrices and bias vectors, in the memory and loads them into the processor during inference.

The server feeds the normalized acoustic feature sequence into the speech recognition model and performs forward propagation. In the case of a transformer-type encoder, the server computes query, key, and value projections, multi-head attention outputs, and layer-normalized representations. In the case of a recurrent network, the server computes hidden state updates and output logits sequentially across time steps. The server then applies a decoding algorithm, such as beam search, to integrate an acoustic model score and a language model score. The language model can be implemented as an n-gram statistical model or as another neural network that assigns probabilities to symbol sequences. The server computes a combined objective function, for example a weighted sum of acoustic log-likelihood and language model log-likelihood, and selects the sequence with the highest combined score as the recognition result. This decoding process is not a mere automation of human transcription but instead performs probabilistic sequence optimization with respect to learned statistical models, which humans cannot replicate at comparable speed or scale.

The server maintains speaker characteristic information and vocabulary information for each user in a storage medium, such as a relational database or a document-oriented database. The server stores, for each user, parameters such as a speaker embedding vector obtained by passing examples of the user's speech through a separate speaker embedding network, feature normalization statistics, and adaptation parameters for acoustic and language models. The server also stores a user-specific lexicon, frequent phrases, and topic-specific word lists relevant to a care environment.

The server uses these stored parameters in a non-conventional manner to adapt model behavior. For acoustic adaptation, the server can insert a linear transformation layer or bias vector into one or more layers of the acoustic model and compute adapted activations by applying the user-specific transformation. For language adaptation, the server can increase the prior probability of user-specific words by adjusting language model logits or by augmenting beam search scoring with additional bias terms when such words appear in candidate hypotheses. The server updates these adaptation parameters over time based on accumulated recognition logs, using optimization algorithms such as stochastic gradient descent or second-order approximations restricted to the low-dimensional adaptation space. By constraining adaptation to specific subspaces and using numerical optimization methods, the server improves recognition accuracy while preventing catastrophic forgetting of base model capabilities.

The server normalizes the recognized character string data. The server converts variant forms of characters to standard forms, expands abbreviations, and standardizes numeric expressions according to predefined rules stored in a text normalization module. The server performs linguistic unit segmentation, for example sentence segmentation and phrase boundary detection, using rules and statistical models that consider punctuation, pause patterns, and probability of boundary markers. The server produces a linguistic feature sequence by mapping text to sequences of phonetic symbols, stress markers, and part-of-speech tags using a grapheme-to-phoneme conversion engine and a morphological analyzer. The server then provides these linguistic features as input to a speech synthesis model.

The server uses a speech synthesis model implemented as a neural network. In one embodiment, the server uses an acoustic model that predicts mel-spectrogram frames from linguistic features, and a vocoder model that converts mel-spectrograms to time-domain waveforms. The acoustic model can be a sequence-to-sequence network with an encoder, an attention mechanism, and a decoder, or a non-autoregressive network that predicts all frames in parallel. The vocoder can be implemented as a generative adversarial network or an autoregressive waveform model. The server stores model parameters, including convolutional filter weights and batch normalization parameters, and uses them during inference.

The server modifies prosodic parameters according to preference information. The server retrieves, from a user profile, a desired speaking rate, pitch range, and prosodic style flags such as “calm” or “lively.” The server adjusts duration predictions and fundamental frequency contours produced by the acoustic model by scaling or shifting predicted values. The server also adjusts pause durations between phrases to produce slower or faster overall speech. These operations occur as mathematical transformations on model outputs and are not simply a matter of selecting pre-recorded messages.

The terminal uses a digital-to-analog converter and an amplifier to drive a speaker as the acoustic output unit. The terminal receives synthesized audio frames from the server, fills a playback buffer in memory, and uses an audio driver to stream samples to the hardware. The terminal measures ambient sound level with the microphone or another sensor and dynamically adjusts output volume and optional equalization filters so that speech remains intelligible in noisy environments without unnecessarily high power consumption. This dynamic control involves real-time computation of long-term and short-term level statistics and feedback control of gain parameters.

The server stores recognized text, associated speaker identifiers, timestamps, and context tags as structured records in a database. The server maintains an index on user identifiers and time fields to support efficient querying and aggregation. The server uses background processes to compute derived metrics such as frequency of health-related complaints or changes in appetite expressions. This structured logging is not merely a business record; it feeds into the adaptation pipeline. For example, if the server detects that specific medical terms occur frequently but are still occasionally misrecognized, the server increases the vocabulary bias parameters for those terms and optionally updates internal pronunciation dictionaries, which directly improves subsequent recognition accuracy.

The server interfaces with an external generative AI model through a generative AI interface module. The server constructs prompt sentences in natural language that include descriptions of current recognition performance, typical user utterances, desired customization goals, and constraints. For example, the server can construct a prompt such as:

“Please propose detailed methods to customize speech recognition models for elderly users with unclear articulation, including acoustic model adaptation, language model personalization, and user-specific pronunciation dictionaries.”

The server can also construct a prompt such as:

“Please generate example dialogue templates suitable for communication between elderly users with hearing impairments and caregivers in a nursing home, including phrases about meals, medication, and physical condition.”

The server can further construct a prompt such as:

“Please describe a step-by-step implementation plan for a text-to-speech module that produces natural, fluent, and easy-to-understand speech for elderly-care scenarios, including model choice and prosody tuning.”

The server transmits such prompt sentences as part of inquiry data via a network protocol to the external generative AI model and receives response data. The server parses the response data to extract proposed adaptation strategies, candidate vocabulary items, or dialogue templates. The server then updates its internal data structures, such as user lexicons, text template repositories, or hyperparameter configurations, according to rules stored in the generative AI interface module. In this way, the server does not merely present generative AI responses to humans but automatically incorporates structured elements of those responses into the internal configuration of the recognition and synthesis pipeline, thereby improving model behavior.

The server uses specific learning methods during training or adaptation phases. The server defines a loss function for the speech recognition model, such as a connectionist temporal classification loss or a sequence-to-sequence cross-entropy loss, and performs gradient-based optimization to minimize this loss on training data that include speech from target user populations. The server uses regularization techniques such as dropout and weight decay to prevent overfitting. For adaptation, the server restricts updates to a subset of parameters, for example low-rank transformation matrices, and optimizes these parameters using stochastic gradient descent with a small learning rate to ensure stable adaptation. The server may use data augmentation techniques such as adding simulated background noise, varying speaking rate, or applying vocal tract length perturbation to increase robustness of the models to variations in real-world conditions.

The server uses specific data structures to manage the processing pipeline. The server represents audio frames as arrays of fixed-length sample sequences, feature vectors as multi-dimensional arrays with time and feature dimensions, and recognition outputs as symbol sequences with associated scores. The server passes these data structures through modules in a predefined order. The server allocates ring buffers or queues for inter-module communication and uses identifiers to tag data with user information and timestamps. This structured data flow ensures that the system can handle multiple concurrent sessions efficiently while maintaining low latency.

The terminal and the server together implement processing that improves computer technology beyond simple automation of human tasks. By performing noise reduction and speech enhancement at the terminal using frequency-domain algorithms and transmitting an enhanced audio signal, the system reduces bandwidth usage and server-side computation otherwise needed to handle raw noisy audio. By maintaining and applying speaker adaptation parameters and vocabulary bias parameters in the server according to a defined mathematical framework, the system achieves recognition accuracy gains that exceed those of generic models without adaptation. By integrating a generative AI model in a controlled manner to generate and apply model customization strategies and dialogue templates, the system continuously improves its internal configurations without requiring manual reprogramming. These improvements reduce recognition errors, stabilize inference times, and optimize storage and communication overhead, thereby enhancing the functioning of the underlying computer infrastructure.

In another embodiment, the terminal includes a more capable application processor, such as a processor used in portable information terminals, and runs an operating system. In such an embodiment, the terminal performs some of the feature extraction or even lightweight speech recognition using a compressed model, while the server performs full recognition and synthesis. In another embodiment, the server distributes recognition and synthesis workloads across multiple computing nodes, each storing a portion of the model parameters. In a further embodiment, the system uses an alternative neural architecture for speech recognition, such as a transducer model that directly outputs symbol sequences conditioned on acoustic input. In yet another embodiment, the speech synthesis model is replaced with a parametric model that predicts excitation and spectral envelope parameters that are then used to drive a vocoder algorithm.

The user utilizes the system by wearing the terminal device and speaking naturally in everyday situations, such as in a care facility, at home, or in public. The terminal captures the user's utterances, and the server converts them into clear synthesized speech and structured text. The caregiver or family member listens to the synthesized speech and, if needed, later reviews the logged text as care record information. In all embodiments, the technical configuration and operations of the terminal and server are designed to improve the performance, accuracy, robustness, and efficiency of computer-implemented speech processing.

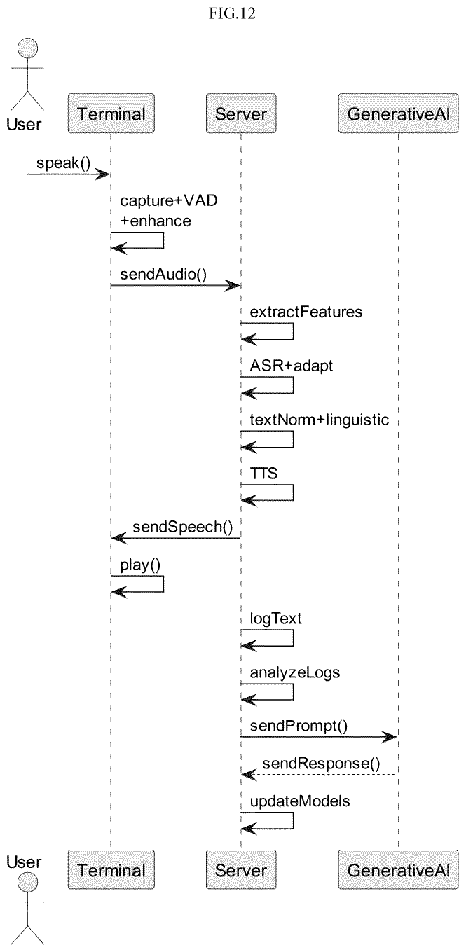

The following describes the processing flow using FIG. 12.

### Step 1:

The user provides a voice utterance as an acoustic input.

The terminal captures the analog sound pressure signal via the microphone and converts it into a digital audio signal. As input, the terminal receives the continuous analog waveform corresponding to the user's speech and background noise. The terminal samples this waveform at a predetermined sampling rate (for example, 16 kHz) with a fixed bit depth (for example, 16 bits), and the analog-to-digital converter outputs a stream of pulse-code modulated samples. The terminal segments this stream into fixed-length frames (for example, 25 ms) with a specified frame shift (for example, 10 ms) and stores these frames in an input buffer in memory. The output of this step is a sequence of framed digital audio samples tagged with a user identifier and timestamps.

### Step 2:

The terminal performs voice activity detection on the framed digital audio samples.

As input, the terminal receives the framed digital audio sequence from the input buffer. The terminal computes frame-level features such as short-time energy and zero-crossing rate, and optionally uses a small classifier to judge whether each frame contains speech or non-speech. The terminal compares these features against thresholds or classifier outputs to label each frame as voice or non-voice. The terminal updates a state machine that tracks the start and end of voice segments and discards or compresses purely silent sequences. The output of this step is a labeled sequence of frames in which each frame carries a voice/non-voice label and only voice segments are passed to the subsequent processing.

### Step 3:

The terminal performs frequency-domain analysis and noise estimation for the voice and non-voice frames.

As input, the terminal receives the labeled frames of digital audio. The terminal applies a window function, such as a Hamming window, to each frame and computes a short-time Fourier transform using a fast Fourier transform algorithm to obtain complex spectra. For frames labeled as non-voice, the terminal averages the magnitude spectra over multiple frames to estimate a noise spectrum and stores this as a noise profile in memory. For frames labeled as voice, the terminal retains the magnitude spectra and phase spectra for later enhancement. The output of this step is a noise profile and a set of spectral representations of voice frames.

### Step 4:

The terminal performs noise reduction and speech enhancement using spectral subtraction or filtering.

As input, the terminal receives the noise profile and the spectral representations of the voice frames. For each voice frame, the terminal subtracts the noise magnitude spectrum from the speech magnitude spectrum or applies a Wiener filter gain computed from the estimated signal-to-noise ratio. The terminal then limits negative values to zero or a floor level to avoid artifacts, and applies a band-emphasis filter that increases gain in speech-related frequency bands while optionally decreasing gain in low- or high-frequency bands that mostly contain noise. The terminal combines the enhanced magnitude spectra with the original phase spectra and computes an inverse fast Fourier transform, followed by overlap-add, to reconstruct time-domain samples. The output of this step is an enhanced audio signal, represented as a sequence of noise-reduced time-domain frames with improved speech intelligibility.

### Step 5:

The terminal normalizes the enhanced audio signal and prepares transmission packets.

As input, the terminal receives the enhanced time-domain frames. The terminal computes statistics such as the maximum absolute sample value or root-mean-square level over a sliding window and scales the samples to maintain a target amplitude range, thereby avoiding clipping and stabilizing input levels for the server. The terminal then groups samples into packets, adds headers containing user identifiers, sequence numbers, and timestamps, and encrypts the payload using a predetermined encryption algorithm and key. The output of this step is a stream of encrypted packets containing normalized enhanced audio samples, ready for transmission to the server.

### Step 6:

The terminal transmits the encrypted packets to the server via the wireless communication unit.

As input, the terminal receives the stream of encrypted packets. The terminal opens or maintains a network connection using a communication protocol, such as a local wireless protocol stack, and writes the packets to the transmit buffer of the network interface. The terminal monitors acknowledgments, retransmits lost packets, and may adjust sending rate based on network conditions. The output of this step is the successful delivery of encrypted enhanced audio packets to the server, along with metadata indicating delivery status.

### Step 7:

The server receives and reconstructs the enhanced audio stream from the packets.

As input, the server receives encrypted packets via the network interface. The server verifies packet integrity using sequence numbers and checksums, decrypts the payload using the corresponding decryption key, and reorders packets if needed to restore the original time sequence. The server concatenates the decrypted payloads into a continuous sequence of enhanced audio samples and segments them back into frames corresponding to the original framing parameters. The output of this step is a reconstructed enhanced audio signal at the server side, aligned in time and associated with the user identifier.

### Step 8:

The server extracts acoustic features from the enhanced audio frames.

As input, the server receives the enhanced audio frames associated with a user. The server applies pre-emphasis to emphasize higher frequencies, then applies a window function and computes a short-time Fourier transform for each frame. The server passes the magnitude spectra through a set of Mel-scaled filterbanks and computes filterbank energies, then applies a logarithm and, if needed, a discrete cosine transform to obtain Mel-frequency cepstral coefficients or related features. The server then performs mean and variance normalization using speaker-specific statistics retrieved from a profile database. The output of this step is an acoustic feature sequence, represented as a time-ordered series of feature vectors ready for input to the speech recognition model.

### Step 9:

The server performs deep-learning-based speech recognition to obtain character string data.

As input, the server receives the acoustic feature sequence and the user identifier. The server feeds the feature sequence into a neural network model, such as an encoder-decoder architecture or a temporal classification network. The server computes layer-by-layer transformations, including linear projections, nonlinear activations, attention computations, and normalization. The server obtains, for each time step or output position, probability distributions over possible output symbols. The server performs decoding, for example by beam search, while combining acoustic model probabilities with language model probabilities and applying user-specific vocabulary bias parameters. The output of this step is one or more candidate text hypotheses, and the server selects the best hypothesis as the recognition result, outputting character string data with an associated confidence score.

### Step 10:

The server updates and applies speaker adaptation parameters and vocabulary bias parameters.

As input, the server receives the recognition result and the acoustic feature sequence. The server compares recognition hypotheses with existing logs and identifies systematic errors, such as frequently misrecognized syllables or words. The server adjusts speaker adaptation parameters, such as a speaker embedding or transformation matrices, by computing gradients of a loss function with respect to these parameters and updating them using an optimization rule. The server also adjusts vocabulary bias parameters by increasing or decreasing weights associated with specific words in the language model or bias list. The server stores the updated parameters in the user profile. The output of this step is an updated set of speaker adaptation parameters and vocabulary bias parameters that will be applied to subsequent recognition operations to improve accuracy.

### Step 11:

The server performs text normalization and linguistic unit segmentation on the recognized text.

As input, the server receives the recognized character string data. The server applies rules and models to standardize character forms, expand abbreviations, and normalize numerical expressions, thereby producing canonical text. The server analyzes punctuation, syntactic cues, and probability patterns to segment the text into sentences and phrases that correspond to natural prosodic units. The output of this step is a normalized and segmented text sequence, annotated with sentence and phrase boundaries, ready for speech synthesis processing.

### Step 12:

The server generates a linguistic feature sequence for speech synthesis.

As input, the server receives the normalized and segmented text. The server applies a grapheme-to-phoneme converter to transform textual units into phoneme sequences and uses morphological analysis and part-of-speech tagging to annotate words with linguistic features. The server also assigns prosodic labels, such as stress patterns and initial prosodic contours, based on linguistic rules and models. The output of this step is a linguistic feature sequence that encodes phonetic, syntactic, and initial prosodic information for each unit in the text.

### Step 13:

The server generates acoustic features for synthesis and converts them to an audio waveform.

As input, the server receives the linguistic feature sequence and user preference information. The server feeds the linguistic features into a neural speech synthesis model, which predicts a sequence of acoustic frames, such as mel-spectrogram frames. The server adjusts predicted duration values and fundamental frequency contours according to the user's desired speaking rate and pitch range. The server then passes the adjusted spectrogram frames into a vocoder model, which predicts time-domain waveform samples by applying convolutional or autoregressive computations. The output of this step is a synthesized audio waveform that expresses the recognized text with prosody tailored to the user's preferences.

### Step 14:

The server transmits the synthesized audio waveform to the terminal.

As input, the server receives the continuous stream of synthesized audio samples. The server segments the waveform into packets, adds headers with user identifiers, sequence numbers, and format information, and encrypts the payload. The server sends these packets through the network interface to the terminal using the established communication channel. The output of this step is a stream of encrypted packets containing synthesized audio data, delivered to the terminal.

### Step 15:

The terminal reconstructs and plays back the synthesized audio waveform.

As input, the terminal receives encrypted packets containing synthesized audio samples. The terminal decrypts the payloads, checks sequence numbers, and reassembles the original waveform by concatenating payload data in order. The terminal fills an audio playback buffer with the reconstructed samples and uses an audio driver to send them to a digital-to-analog converter. The terminal monitors ambient sound level and adjusts output gain and optional equalizer settings to ensure intelligibility. The output of this step is audible synthesized speech emitted from the speaker, allowing caregivers or family members to understand the user's intended message.

### Step 16:

The server logs recognized text and associated data as structured care records.

As input, the server receives the final recognized text, timestamps, user identifiers, and context labels, such as activity type. The server creates a structured record that includes fields for user ID, time, text content, recognition confidence, and optional category labels. The server inserts this record into a database table or document collection and updates indexes to support efficient querying. The output of this step is an updated care record database that stores communication history in a structured, searchable form.

### Step 17:

The server analyzes accumulated records to refine recognition and synthesis behavior.

As input, the server receives multiple stored records over time. The server runs analysis routines that compute statistics such as word frequency distributions, co-occurrence patterns, and topic trends. The server identifies words or phrases that are frequent but occasionally misrecognized and computes updated vocabulary bias parameters to increase their recognition likelihood. The server also detects typical sentence patterns and can adjust text-to-speech prosody templates to better match common expressions. The output of this step is refined model configuration data, including updated bias lists, prosody templates, and adaptation parameters, which are used to further improve subsequent speech processing.

### Step 18:

The server interacts with an external generative AI model to obtain customization strategies and dialogue templates.

As input, the server receives internal performance data, user profiles, and requirements for customization. The server constructs a prompt sentence in natural language that describes the current challenges and desired improvements, such as:

“Please propose detailed methods to customize speech recognition models for elderly users with unclear articulation, including acoustic model adaptation, language model personalization, and user-specific pronunciation dictionaries.”

The server sends this prompt as part of inquiry data to the external generative AI model via a network interface. The server receives response data, parses the generated text to extract algorithmic suggestions, candidate phrases, or template structures, and converts them into internal data structures, such as updated lexicons or dialog template lists. The output of this step is an updated set of customization rules and textual resources derived from the generative AI model and stored in the system for subsequent use.

### Step 19:

The server applies generative-AI-derived information to update internal parameters and templates.

As input, the server receives the processed suggestions and templates from the generative AI interaction. The server identifies relevant parameters, such as lists of domain-specific vocabulary, recommended adaptation procedures, or proposed dialogue patterns. The server updates configuration files, database entries, and model hyperparameters in accordance with predefined safety and consistency checks. The server then signals the recognition and synthesis modules to reload or reinitialize with the new configurations. The output of this step is a modified recognition and synthesis pipeline that incorporates generative-AI-derived improvements, leading to increased accuracy, better domain coverage, and more appropriate dialogue templates for communication support.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional speech assistance systems for users having unclear articulation, computer processing mainly focuses on converting an input acoustic signal into a more intelligible acoustic signal. Existing systems typically apply noise reduction and automatic speech recognition, and then perform text-to-speech synthesis using a fixed voice profile. However, such systems generally treat the recognized text as a static sequence of characters and do not computationally model or control emotional state, politeness level, or contextual appropriateness in a systematic way. As a result, these systems often fail to convey the user's intended emotional nuance while maintaining safety and suitability for a given usage scene, such as a business meeting or a medical consultation.

From a computer technology perspective, several technical deficiencies arise.

First, conventional architectures do not integrate multi-modal emotion estimation into the speech pipeline at the system level. While individual classifiers for emotional tone in acoustic features or text features may exist, typical speech assistance systems do not combine audio feature vectors and text feature vectors within a unified machine learning architecture to produce an emotion state that is then used programmatically as a control signal for downstream processing. Consequently, the computing system cannot leverage emotional information to dynamically control prosody parameters of synthesized speech.

Second, conventional systems do not exploit a generative artificial intelligence model under programmatic control using structured prompt sentences to perform context-aware text adjustment and prosody policy design. In many implementations, text output from speech recognition is passed directly to a text-to-speech engine, or at most subjected to simple rule-based rewriting. There is no general-purpose processing pipeline in which a processor constructs prompt sentences that encode recognized text, estimated emotion, and scene information, calls a generative model as a configurable computational component, and then automatically integrates generated text adjustment candidates back into the speech synthesis path under explicit safety constraints. This leads to limited flexibility, reliance on rigid heuristics, and an inability to adapt style, politeness, and expression strength to different scenes while preserving semantic content.

Third, existing systems lack a technical framework for using user feedback as machine-readable evaluation information to update emotion estimation models in a robust online or batch learning manner. Even where feedback mechanisms are present, they are often treated as annotations for offline analysis and not as first-class input to a learning unit that programmatically adjusts model parameters at runtime or periodically. In addition, prior systems do not employ a generative artificial intelligence model to assist in the configuration of learning algorithms, noise-robust techniques, and learning-rate scheduling strategies, so the model update process is typically hand-tuned and suboptimal. As a result, the computing system cannot efficiently adapt to individual users' emotional expression patterns, and emotion estimation accuracy remains limited.

Fourth, conventional systems lack an integrated safety determination mechanism that programmatically evaluates generative outputs for inappropriate or offensive expressions before those outputs are used as input to speech synthesis. When a generative model is used in an ad hoc manner, its outputs may be forwarded directly to the synthesis engine, causing a risk that unsafe or contextually unsuitable expressions are synthesized and output in real time. This represents not only a usability problem but also a technical risk in the control flow of a network-connected speech assistance system.

Accordingly, there is a need for an improved computer-implemented system and method that: (i) performs multi-modal emotion estimation from both audio and text features; (ii) uses a generative artificial intelligence model via structured prompt sentences to generate context-appropriate text adjustment candidates and to design prosody control rules; (iii) incorporates a safety determination unit to filter generative outputs; and (iv) updates the underlying emotion estimation model using user feedback, optionally guided by generative-model-assisted recommendations on learning algorithms and hyperparameters. By addressing these deficiencies, the system can improve the operation of computers that perform speech processing for users with unclear articulation, leading to enhanced accuracy, adaptability, and safety in real-time communication support.

The specific processing by the specific processing unit 290 of the data processing device 12 in Example 2 is realized by the following means.

The present invention provides a server comprising a processor configured to execute instructions to acquire a user utterance as an audio signal via a sound collection unit, perform signal processing including noise reduction, frequency characteristic correction, and volume normalization on the audio signal to generate preprocessed audio data suitable for speech recognition, generate string data based on the preprocessed audio data by executing a speech recognition unit including a machine learning model, calculate audio feature quantities from the preprocessed audio data and text feature quantities from the string data, estimate an emotional state of the user based on the audio feature quantities and the text feature quantities by executing an emotion estimation unit, construct a prompt sentence in a natural language including the string data and the estimated emotional state, input the prompt sentence to a generative artificial intelligence model, obtain from the generative artificial intelligence model a text adjustment candidate having a meaning equivalent or similar to that of the string data with an adjusted style, politeness, and expression strength, determine whether the text adjustment candidate includes an inappropriate expression, an offensive expression, or an expression unsuitable for a usage scene, adopt one of the text adjustment candidate and the string data as text for speech synthesis based on a result of the determination by executing a safety determination unit, determine prosody control parameters for controlling at least one of speaking rate, fundamental frequency, volume, and intonation in accordance with scene information indicating the usage scene and the estimated emotional state, generate an audio signal based on the adopted text for speech synthesis and the prosody control parameters by executing a speech synthesis unit, transmit the generated audio signal to a terminal device, cause the terminal device to output the audio signal from an acoustic output device, acquire evaluation information from the user regarding the estimation result of the emotion estimation unit and appropriateness of audio output, and update parameters of the machine learning model in the emotion estimation unit based on the acquired evaluation information to improve estimation accuracy of the emotional state. This enables a computer system to dynamically integrate multi-modal emotion estimation, generative-model-based text adjustment, prosody control, safety filtering, and user-feedback-driven model updating within a unified processing pipeline, thereby improving the technical performance, adaptability, and safety of speech processing for users with unclear articulation.

The term “processor” refers to a hardware information processing unit, such as a central processing unit, a microprocessor, or a set of processing cores, that executes instructions to perform arithmetic operations, logical operations, control operations, and data transfer operations.

The term “user utterance” refers to a sequence of sounds produced by a human user, including speech with clear or unclear articulation, that is intended to convey linguistic content and is captured as an audio signal.

The term “audio signal” refers to an analog or digital representation of sound pressure variations over time, including but not limited to pulse code modulated data or compressed audio data.

The term “sound collection unit” refers to a combination of at least one acoustic sensor and associated circuitry that detects sound in an environment and outputs an audio signal, and may include a microphone, an analog front end, and an analog-to-digital converter.

The term “signal processing” refers to computational operations applied to an audio signal, including but not limited to noise reduction, filtering, dynamic range control, and normalization, in order to modify or analyze the signal.

The term “noise reduction” refers to processing that estimates and suppresses components of an audio signal that originate from environmental noise, background noise, or interference rather than from the target speech.

The term “frequency characteristic correction” refers to processing that adjusts an audio signal's spectral distribution so as to compensate for device characteristics or to emphasize a frequency band of interest.

The term “volume normalization” refers to processing that adjusts the amplitude or energy level of an audio signal to fall within a predetermined target range.

The term “preprocessed audio data” refers to audio data that has been subjected to one or more signal processing operations, including noise reduction, frequency characteristic correction, and volume normalization, and is therefore suitable for subsequent analysis such as speech recognition.

The term “speech recognition unit” refers to a functional component that converts preprocessed audio data into text data, typically by using a machine learning model that maps acoustic features to linguistic units.

The term “machine learning model” refers to a parametric computational model whose parameters are learned from training data by an optimization algorithm, and includes, for example, neural networks, probabilistic models, and other statistical models.

The term “string data” refers to digital data representing a sequence of characters, symbols, words, or tokens that express the content of recognized speech in a textual form.

The term “audio feature quantities” refers to numerical values derived from an audio signal that characterize acoustic properties of the signal, including but not limited to fundamental frequency, energy, spectral coefficients, and temporal statistics.

The term “text feature quantities” refers to numerical values derived from text data that characterize linguistic or semantic properties of the text, including but not limited to token embeddings, sentence embeddings, and frequency-based features.

The term “emotion estimation unit” refers to a functional component that receives audio feature quantities and text feature quantities and outputs an estimated emotional state of a user, typically by executing a machine learning model.

The term “emotional state” refers to information indicating an affective condition of a user, including at least a category such as joy, anger, anxiety, sadness, or neutral, and optionally an intensity or confidence value.

The term “prompt sentence” refers to a natural language text or similar structured instruction supplied as input to a generative artificial intelligence model to specify a desired processing behavior or output format.

The term “generative artificial intelligence model” refers to a trained computational model that generates output data, such as text, parameters, or other structured information, in response to input data including prompt sentences, and includes, for example, large language models.

The term “text adjustment candidate” refers to text generated by the generative artificial intelligence model that preserves a meaning equivalent or similar to that of given string data while modifying one or more attributes such as style, politeness, or expression strength.

The term “text adjustment unit” refers to a functional component that constructs a prompt sentence including string data and an emotional state, inputs the prompt sentence to a generative artificial intelligence model, and obtains at least one text adjustment candidate.

The term “safety determination unit” refers to a functional component that evaluates text, including a text adjustment candidate, to determine whether it contains an inappropriate expression, an offensive expression, or an expression unsuitable for a usage scene, and selects text for subsequent processing based on a result of the evaluation.

The term “usage scene” refers to contextual information indicating a type of situation in which the system is used, such as a business meeting, a casual conversation, or a medical setting.

The term “scene information” refers to data that represents a usage scene and is used by the system to control behavior such as prosody adjustment or safety filtering.

The term “prosody control parameters” refers to numerical values or control signals used to adjust prosodic characteristics of synthesized speech, including at least one of speaking rate, fundamental frequency, volume, and intonation.

The term “prosody control rules” refers to a set of mappings or conditions that define how prosody control parameters are determined based on at least an emotional state and scene information.

The term “speech synthesis unit” refers to a functional component that generates an audio signal representing synthetic speech from text and prosody control parameters, typically by using a text-to-speech model such as a neural network.

The term “audio output device” refers to hardware that converts a digital or analog electrical signal into sound waves, and includes, for example, a loudspeaker or an earphone.

The term “terminal device” refers to an end-user computing apparatus, such as a wearable device, a mobile device, or another client device, that communicates with the server and outputs synthesized audio to a user or to a surrounding environment.

The term “communication unit” refers to a functional component that transmits and receives data between the server and a terminal device via a communication network, and may include wired or wireless interfaces and associated protocol stacks.

The term “evaluation information” refers to data provided by a user that indicates an assessment of system outputs, including at least an evaluation of correctness of an estimated emotional state and appropriateness of synthesized audio, and may further include corrected labels or comments.

The term “evaluation information acquisition unit” refers to a functional component that receives evaluation information from a user, directly or via a terminal device or external device, and supplies the evaluation information to other components of the system.

The term “learning unit” refers to a functional component that updates parameters of a machine learning model based on evaluation information or other training data, by executing a learning algorithm such as gradient-based optimization.

The term “online learning algorithm” refers to a learning algorithm that updates model parameters incrementally as new data or feedback becomes available, rather than only in large offline training batches.

The term “noise label mitigation method” refers to a technique used in training a machine learning model to reduce the adverse impact of incorrect or noisy labels in training data, including but not limited to sample reweighting, label smoothing, or outlier filtering.

The term “learning rate scheduling strategy” refers to a rule or function that defines how the learning rate of an optimization algorithm changes over time or over iterations during training.

The term “numerical parameter values” refers to quantitative values used as configuration parameters for controlling system behavior, including numeric settings for prosody control or learning algorithm hyperparameters.

The term “hyperparameters” refers to configuration parameters of a machine learning model or learning algorithm, such as learning rate, batch size, regularization strength, or architecture-related choices, that are set externally to the training process.

In the following embodiments, a server, a terminal, and a user cooperate to implement the claimed system. The server and the terminal are realized by hardware computing devices operating under control of executable software modules. The user is a human operator who wears the terminal and provides speech and feedback.

### 1. Hardware and Software Configuration of the Terminal

The terminal includes a sound collection unit, a communication interface, a processor, a memory, and an audio output device.

The terminal uses a directional microphone as the sound collection unit. The terminal connects the microphone to an analog front end and an analog-to-digital converter (ADC). The terminal samples the analog voice signal at, for example, 48 kHz and 16-bit resolution, and stores the resulting pulse code modulated (PCM) samples in a memory buffer.

The terminal uses an embedded processor, such as a microcontroller or a low-power application processor, executing an embedded operating system, such as a real-time operating system, to run a signal processing program. The terminal uses a digital signal processing library implementing fast Fourier transform (FFT), inverse fast Fourier transform (IFFT), and digital filters.

The terminal performs noise reduction, frequency characteristic correction, and volume normalization. The terminal executes FFT on short-time frames of the PCM signal, estimates noise spectra from low-energy segments, and subtracts the estimated noise magnitude from the observed spectrum. The terminal applies a band-pass filter in the frequency domain to emphasize the speech band (for example approximately 300-3400 Hz). The terminal performs dynamic range compression by applying a non-linear amplitude function to reduce level variations. The terminal converts the processed spectra back to the time domain using IFFT and overlap-add, and thereby generates preprocessed audio data.

The terminal uses a wireless communication module, such as a short-range radio module or a wireless local area network module, together with a protocol stack implementing transport protocols and security protocols. The terminal packetizes the preprocessed audio data into frames, attaches metadata such as user identifiers and timestamps, and encrypts the packets.

The terminal uses a digital-to-analog converter (DAC), an amplifier, and a speaker as the audio output device. The terminal receives synthesized audio data from the server, decodes and converts the data to PCM, and outputs the corresponding sound through the speaker.

By executing this signal preprocessing on the terminal side, the terminal reduces the impact of environmental noise and limits the bandwidth of transmitted audio, which leads to reduced communication load and improved recognition accuracy at the server. This division of processing between the terminal and the server improves overall system performance and reduces latency compared to systems that transmit raw audio without preprocessing.

### 2. Hardware and Software Configuration of the Server

The server includes at least one general-purpose processor, a main memory, a non-volatile storage device, and a network interface. The server executes a general-purpose server operating system. The server runs application software implementing modules corresponding to a speech recognition unit, an emotion estimation unit, a text adjustment unit, a safety determination unit, a speech synthesis unit, an evaluation information acquisition unit, a learning unit, and a communication unit.

The server stores a speech recognition model, an emotion estimation model, and a speech synthesis model in the non-volatile storage device. The server loads these models into memory at runtime and executes them using a machine learning framework, such as a deep learning library.

The server uses additional libraries for audio feature extraction, such as computation of mel spectrograms, mel-frequency cepstral coefficients (MFCCs), fundamental frequency, and energy. The server uses a natural language processing library and a pretrained language model to compute text embeddings. The server uses an application-level routine to construct prompt sentences and to interface with an external or internal generative AI model.

### 3. Speech Recognition and Feature Extraction Embodiment

The server receives preprocessed audio data from the terminal through the communication unit. The server reconstructs an audio stream by reordering and concatenating the received frames. The server segments the audio stream into recognition units according to voice activity or fixed time windows.

The server computes acoustic features such as log-mel spectrograms from each recognition unit. The server uses a speech recognition model, for example a neural network such as a sequence-to-sequence model, a recurrent neural network transducer, or a transformer-based model. The server feeds the acoustic features into this model and obtains a sequence of token probabilities.

The server applies a decoding algorithm such as beam search in combination with a language model to output string data corresponding to the recognized text. The language model may be a recurrent or transformer-based network trained on a large corpus of text.

The server then computes audio feature quantities from the same recognition unit. The server calculates fundamental frequency contours, energy trajectories, MFCCs, and statistics such as mean, variance, maximum, and minimum. The server also estimates speaking rate by dividing the number of recognized syllables or characters by the duration of the utterance, and determines pause durations between segments of speech.

The server computes text feature quantities from the recognized string data. The server tokenizes the sentence and obtains word or subword embeddings using a pretrained language model. The server derives a sentence-level embedding as a pooled representation.

The server concatenates the audio feature quantities and the text feature quantities to generate a multi-modal feature vector. Because the server unifies acoustic and textual information within a single feature representation, the emotion estimation process can exploit patterns that are not readily visible when only one modality is used. This integration improves classification accuracy and reduces misclassification of subtle emotional expressions.

### 4. Emotion Estimation Model Embodiment

The server uses the multi-modal feature vector as input to the emotion estimation unit. The server implements the emotion estimation unit as a neural network, for example a multi-layer perceptron or a transformer encoder. The server includes a first layer mapping the concatenated feature vector into a hidden space, multiple hidden layers with non-linear activation functions such as rectified linear units, and an output layer producing logits for each emotion category. The server applies a softmax function to obtain probabilities for categories such as joy, anger, anxiety, sadness, and neutral.

The server interprets the maximum probability as the predicted emotion category. The server may use the maximum probability or another function of the logits as an intensity measure and a confidence score.

The server initially trains this emotion estimation model using a training dataset including input features and labeled emotional states. The server uses a loss function such as cross-entropy loss and an optimizer such as stochastic gradient descent or an adaptive variant. The server may apply regularization methods and data augmentation techniques. The server stores the trained model parameters for use in runtime inference.

By using multi-modal features and a model structure specifically designed for emotion estimation, the server achieves higher accuracy than a system relying on simple threshold-based rules or text-only heuristics. This improves the technical performance of the emotion classification engine, which is a core computational component of the system.

### 5. Construction of Prompt Sentences and Generative AI Interface Embodiment

The server uses a text adjustment unit to construct prompt sentences. The server forms a prompt sentence by embedding recognized string data and the estimated emotional state into a template. The server generates a natural-language instruction that specifies the required rewriting conditions, such as maintaining meaning while adjusting politeness and emotional expression to fit a usage scene.

For example, the server constructs a prompt sentence such as:

“The following Japanese sentence and its speaker's emotion label are given.

Sentence: “I'm going to explain this material today, but I'm not very confident.”

Emotion label: “anxiety”

Please rewrite this sentence into a polite expression suitable for a business meeting, without changing its meaning and without making the listener feel uncomfortable.”

The server sends the prompt sentence to a generative AI model via an application programming interface. The generative AI model may reside on a separate inference server or may be integrated into the same physical server. The generative AI model is a large language model trained on a large corpus of text, and it outputs a rewritten sentence.

The server receives the generated output as a text adjustment candidate. The server supports alternative prompt sentences depending on configuration and usage scene. For instance, when designing prosody control rules, the server uses a prompt sentence such as:

“In Japanese speech synthesis, please propose numeric settings for pitch, speaking rate, volume, and intonation to express the emotions joy, anger, anxiety, sadness, and neutral in a restrained way suitable for business meetings.”

By constructing such prompt sentences programmatically, the server uses the generative AI model as a computational component that generates structured outputs under constrained conditions. The server does not simply hand off a human task to the model but integrates the model into a deterministic processing chain with explicit input structures and output validation.

### 6. Safety Determination and Text Selection Embodiment

The server uses a safety determination unit to evaluate text adjustment candidates. The server applies a combination of rule-based filters and machine-learned classifiers to detect inappropriate or offensive expressions. The server may maintain a list of prohibited terms, apply pattern matching to expressions related to harassment, or use a toxicity classifier to compute a probability that the text is unsafe.

The server compares computed safety scores or detection flags against predetermined thresholds. If the text adjustment candidate is judged safe, the server adopts it as the text for speech synthesis. If the text adjustment candidate is judged unsafe or uncertain, the server falls back to the original string data from the speech recognition unit.

This safety determination avoids synthesis of harmful or contextually unsuitable outputs produced by the generative AI model. The safety check is performed within the computational pipeline before control signals for speech synthesis are generated. Therefore, the server ensures that only safe text passes into the subsequent prosody control and synthesis stages, improving system reliability compared to a naive use of generative outputs.

### 7. Prosody Control Rule Construction and Prosody Control Embodiment

The server uses scene information indicating the type of usage context, such as “meeting,” “casual conversation,” or “medical consultation.” The server associates each scene and each emotion category with prosody control parameters, such as speaking rate scaling, fundamental frequency scaling, volume scaling, and intonation range.

The server constructs or updates these prosody control rules with assistance from the generative AI model. The server sends a descriptive prompt sentence regarding emotions and scene requirements to the generative AI model and obtains numeric parameter value suggestions. The server records and optionally adjusts these suggested values and stores them in a prosody control table.

At runtime, the server retrieves prosody control parameters from this table according to the estimated emotional state and scene information. The server may further modulate the parameters based on the emotion intensity, for example by linearly scaling pitch or speaking rate according to intensity.

The server then provides these prosody control parameters to the speech synthesis unit as control signals. The server thereby generates synthetic speech whose prosodic characteristics are deliberately shaped by algorithmic rules rather than being fixed or entirely free-running. This architecture increases control precision and reproducibility and decreases dependency on ad hoc manual tuning of prosody for each new scene.

### 8. Speech Synthesis Embodiment

The server uses a speech synthesis model, such as a neural text-to-speech model, to generate audio signals from text and prosody control parameters. The server may use a model architecture in which a text encoder transforms text tokens into embeddings, an acoustic model predicts an intermediate representation such as a mel spectrogram, and a neural vocoder converts the intermediate representation into a waveform.

The server converts the selected text for speech synthesis (either the original string data or the text adjustment candidate) into a phoneme sequence using a text-to-phoneme module. The server encodes the phoneme sequence into embeddings and concatenates or otherwise conditions these embeddings with the prosody control parameters. For instance, the server may append a control vector containing pitch scaling and speaking rate values to each phoneme embedding.

The server forwards the conditioned embeddings to the acoustic model, which predicts a mel spectrogram sequence. The server then uses the vocoder to synthesize a time-domain waveform. The server outputs PCM data representing the synthesized speech.

Because the prosody control parameters are determined algorithmically from emotion and scene information, the server can systematically achieve different prosodic styles for the same text according to context. This improves technical performance by enabling re-use of a single synthesis model for multiple styles and scenes without retraining the entire model.

### 9. Evaluation Information Acquisition and Learning Embodiment

The server uses an evaluation information acquisition unit to collect feedback from the user. The user listens to the synthesized speech output from the terminal and, through an external device such as a smartphone application, provides evaluation information indicating whether the estimated emotional state matched the actual feeling and whether the synthesized speech was appropriate.

The terminal or external device transmits this evaluation information to the server. The server associates the evaluation data with the corresponding emotion estimation inputs used for that utterance. The server stores the feedback records in a database with identifiers linking them to audio features, text features, and predicted labels.

The server uses a learning unit to update the emotion estimation model. The server periodically selects a batch of feedback records, reconstructs the corresponding input feature vectors, and uses the corrected emotion labels provided by the user as targets. The server computes a loss function such as cross-entropy between the predicted probabilities and the corrected labels, then applies gradient-based optimization to adjust the model parameters.

The server may use a generative AI model to assist in selecting a learning algorithm and hyperparameters. The server sends a prompt sentence describing the feedback structure and the possibility of noisy labels, for example:

“Please propose a robust online learning algorithm to update an emotion classification model using user feedback that contains correction labels. Also describe techniques to mitigate noisy labels and strategies for learning-rate scheduling.”

The server receives a description of suitable algorithms, such as sample reweighting based on agreement, label smoothing, or decayed learning rates, and configures the learning unit accordingly. The server may implement mini-batch updates triggered on a schedule or upon the accumulation of a certain number of feedback instances.

By using user feedback as training data and updating the model periodically, the server adapts to individual expression patterns, which yields technical improvements in classification accuracy compared to static, non-adaptive models. The server also uses algorithmic strategies for noise mitigation suggested via the generative AI model, which reduces overfitting to erroneous labels and stabilizes the learning process.

### 10. Technical Effects and Improvement of Computer Technology

The server and the terminal cooperate to achieve several concrete technical effects that go beyond mere automation of human tasks.

First, by performing signal preprocessing at the terminal and transmitting preprocessed audio data to the server, the system reduces communication bandwidth and improves the signal-to-noise ratio of recognized speech. This leads to faster and more accurate recognition compared to sending raw audio over a constrained network.

Second, by using a multi-modal feature vector that combines audio and text feature quantities, and by employing a dedicated emotion estimation model, the server increases the accuracy of emotion classification and decreases computational waste from misclassified emotions. This improves the efficiency of downstream prosody generation and reduces the number of interactions requiring manual correction.

Third, by integrating a generative AI model through structured prompt sentences, and by validating the outputs through a safety determination unit, the server introduces a non-conventional control structure that uses the generative model as a constrained coprocessor rather than as an unconstrained text generator. This structured usage yields stable and predictable improvements in text style and prosody policies, while preserving semantic content.

Fourth, by using a prosody control table designed programmatically and optionally refined by generative AI suggestions, the server reuses a common synthesis engine across multiple scenes without manual tuning for each new context. This directly improves computational resource utilization and reduces the need for re-training multiple separate synthesis models.

Fifth, by implementing an evaluation feedback loop with automated model updating, the server performs continual improvement of the emotion estimation model in an online or periodic fashion. The server thereby enhances emotion recognition performance over time for individual users and reduces error rates. The use of noise-robust learning techniques and learning-rate schedules further contributes to stable convergence and improved processing speed.

These aspects collectively improve the operation of a computer system for speech processing, including accuracy of recognition and emotion estimation, efficiency of data transmission, and robustness and safety of generative text processing. The described architecture is not a generic automation of a human activity but instead relies on specific data structures, algorithms, and model architectures implemented in hardware and software to achieve technical improvements.

### 11. Variations and Alternative Embodiments

The server may use alternative model architectures for speech recognition, emotion estimation, and speech synthesis. For example, the server may replace a sequence-to-sequence recognition model with a connectionist temporal classification-based model, or may replace a transformer encoder for emotion estimation with a convolutional network or a hybrid recurrent-convolutional network.

The server may implement the safety determination unit entirely through a learned classifier, entirely through rule-based filters, or through a combination of both. The server may store safety rules in a configurable data structure and may update them as necessary.

The terminal may be implemented as a wearable device, a handheld device, or a stationary device. The microphone arrangement and sampling parameters may vary according to hardware capabilities. The audio output device may be an in-ear headphone, a bone-conduction speaker, or a loudspeaker.

The generative AI model may be provided by an external service or hosted locally. The server may adapt the prompt sentences according to localization or domain-specific guidelines. The server may use the generative AI model to propose not only prosody control parameters but also other configuration values, such as thresholds for safety filters or parameters for noise mitigation.

In all such variations, the server, the terminal, and the user maintain the fundamental architecture in which preprocessed audio is recognized, emotion is estimated using multi-modal features, generative text adjustment and safety evaluation are performed, prosody is algorithmically controlled according to emotion and scene, and feedback is used to refine the emotion estimation model.

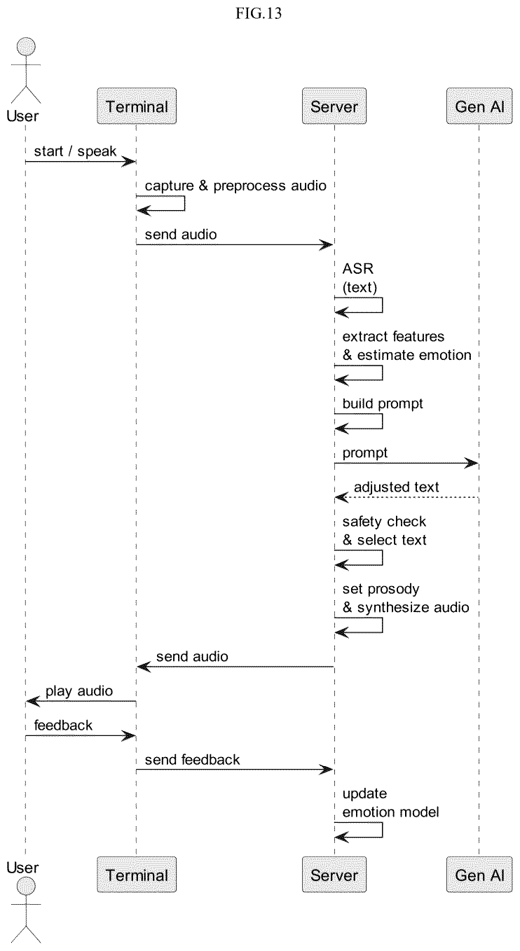

The following describes the processing flow using FIG. 13.

### Step 1:

User wears the terminal and initiates speech capture.

User provides, as input, a physical or software trigger (such as pressing a button on the terminal or tapping a control on an external device) and then produces an utterance. User outputs an acoustic signal in the form of spoken words directed toward the terminal's microphone.

### Step 2:

Terminal captures the utterance and converts it to digital audio.

Terminal receives, as input, the acoustic signal from the user through a microphone. Terminal performs analog-to-digital conversion by sampling the signal at a predetermined sampling rate and resolution (for example, 48 kHz and 16-bit) using an ADC. Terminal writes the resulting PCM samples into a ring buffer in memory. Terminal outputs a continuous stream of raw PCM audio frames representing the user utterance.

### Step 3:

Terminal performs signal preprocessing on the captured audio.

Terminal receives, as input, the raw PCM audio frames from the ring buffer. Terminal uses a digital signal processing library to perform a short-time Fourier transform on each frame, estimates background noise by averaging spectra of low-energy regions, and subtracts the estimated noise spectrum from the observed spectrum. Terminal applies a band-pass filter to emphasize the speech band and performs dynamic range compression to normalize amplitude levels. Based on these data operations, terminal outputs preprocessed audio frames that have reduced noise, corrected frequency characteristics, and normalized volume, which are suitable for speech recognition.

### Step 4:

Terminal packetizes and encrypts the preprocessed audio for transmission.

Terminal receives, as input, the preprocessed audio frames. Terminal groups multiple frames into packets, attaches metadata including user identifiers, session identifiers, sequence numbers, and timestamps, and serializes this information into a data structure. Terminal applies an encryption algorithm provided by a security library to the serialized data. Terminal then sends the encrypted packets via a wireless communication module using a network protocol stack. Terminal outputs a sequence of encrypted network packets containing preprocessed audio data addressed to the server.

### Step 5:

Server receives and reconstructs the preprocessed audio stream.

Server receives, as input, encrypted network packets from the terminal through a network interface. Server uses a communication stack to decrypt each packet, parses the payload to extract preprocessed audio data and associated metadata, and reorders packets by sequence number where necessary. Server concatenates the audio segments to reconstruct a continuous preprocessed audio stream for each user session. Server outputs segmented preprocessed audio data units ready for speech recognition.

### Step 6:

Server performs automatic speech recognition on the preprocessed audio.

Server receives, as input, each segmented preprocessed audio unit. Server computes acoustic features such as log-mel spectrograms using an audio feature extraction library. Server feeds the feature sequence into a speech recognition model implemented in a machine learning framework, applies neural network inference to obtain token probability sequences, and runs a decoding algorithm with a language model to select the most probable text. Based on these data computations, server outputs string data representing the recognized content of the user utterance, along with optional confidence information.

### Step 7:

Server extracts audio and text feature quantities for emotion estimation.

Server receives, as input, the preprocessed audio segment and the corresponding string data. Server computes audio feature quantities such as fundamental frequency contours, energy profiles, MFCCs, speaking rate, and pause durations by applying signal processing functions to the audio. Server computes text feature quantities by tokenizing the string data and generating embeddings using a pretrained language model. Server aggregates these values into numerical vectors and concatenates them to form a multi-modal feature representation. Server outputs an audio feature vector, a text feature vector, and a combined feature vector for use in emotion estimation.

### Step 8:

Server estimates the emotional state from the multi-modal features.

Server receives, as input, the combined feature vector including audio and text feature quantities. Server feeds this vector into an emotion estimation model, such as a neural network with multiple hidden layers, and performs forward propagation to compute logits for each emotion class. Server applies a softmax function to convert logits to class probabilities, selects the class with the highest probability as the emotion label, and derives intensity and confidence from the probability distribution. Server outputs an estimated emotional state including at least an emotion label and a corresponding intensity or confidence value.

### Step 9:

Server constructs a prompt sentence for a generative AI model to adjust text.

Server receives, as input, the string data and the estimated emotional state. Server selects a prompt template corresponding to a usage scene and text-adjustment objective. Server embeds the recognized text and emotion label into the template by string substitution to form a natural-language instruction. As a result of this data construction, server outputs a prompt sentence to be supplied to a generative AI model. For example, server may output:

“The following Japanese sentence and its speaker's emotion label are given.

Sentence: “I'm going to explain this material today, but I'm not very confident.”

Emotion label: “anxiety”

Please rewrite this sentence into a polite expression suitable for a business meeting, without changing its meaning and without making the listener feel uncomfortable.”

### Step 10:

Server sends the prompt sentence to the generative AI model and obtains a text adjustment candidate.

Server receives, as input, the constructed prompt sentence. Server transmits the prompt sentence to a generative AI model via an application programming interface, waits for the model's response, and receives generated text as a reply. Server parses the reply and extracts the rewritten sentence. Based on this input and processing, server outputs a text adjustment candidate that preserves the meaning of the original string data while adjusting style, politeness, or expression strength.

### Step 11:

Server performs a safety determination on the text adjustment candidate.

Server receives, as input, the text adjustment candidate and the original string data. Server applies a safety filter composed of rule-based checks and, optionally, a classifier to detect inappropriate, offensive, or scene-inappropriate expressions. Server computes safety indicators, compares them with predetermined thresholds, and decides whether the candidate is acceptable. If the candidate is safe, server adopts it; otherwise, server falls back to the original string data. Server outputs a selected text for speech synthesis that has passed this safety determination.

### Step 12:

Server determines prosody control parameters based on scene information and emotional state.

Server receives, as input, the selected text for speech synthesis, the estimated emotional state, and scene information identifying the usage context. Server accesses a prosody control table mapping combinations of emotion categories and scenes to parameter values for speaking rate, fundamental frequency, volume, and intonation range. Server retrieves the corresponding parameter set and may further scale these values according to emotion intensity. Server constructs a prosody control vector that encodes these numeric settings. Server outputs the prosody control parameters to be used by the speech synthesis unit.

### Step 13:

Server generates synthetic speech using the selected text and prosody control parameters.

Server receives, as input, the selected text for speech synthesis and the prosody control parameters. Server converts the text into a phoneme or pronunciation sequence using a text-to-phoneme module. Server encodes the phoneme sequence into embeddings and combines these embeddings with the prosody control vector, for example by concatenation or conditioning. Server feeds the conditioned representations into a neural speech synthesis model to predict an acoustic representation such as a mel spectrogram, then passes the representation through a vocoder to generate a waveform. Server outputs synthesized PCM audio data that reflect both the textual content and the controlled prosodic pattern.

### Step 14:

Server compresses and transmits the synthesized audio to the terminal.

Server receives, as input, the synthesized PCM audio data. Server applies an audio codec to compress the waveform into a lower-bitrate format and divides the compressed stream into packets with identifiers and sequence numbers. Server encrypts these packets using a security protocol and sends them through the network interface to the terminal. Server outputs an ordered series of encrypted packets containing the synthesized audio.

### Step 15:

Terminal receives, decodes, and outputs the synthesized audio.

Terminal receives, as input, the encrypted audio packets from the server. Terminal uses its communication stack to decrypt each packet, reorders packets when necessary using sequence information, and concatenates audio segments to reconstruct the compressed stream. Terminal decodes the compressed audio to PCM using an audio decoder. Terminal optionally analyzes ambient sound level via its microphone to determine an appropriate playback volume, adjusts output gain accordingly, and feeds the PCM data to a DAC and amplifier. Terminal outputs the corresponding sound through the speaker as synthesized speech that represents the user's content and controlled emotional expression.

### Step 16:

User listens to the synthesized speech and provides feedback.

User receives, as input, the acoustic output from the terminal. User evaluates whether the synthesized speech accurately reflects the intended content, emotion, and politeness. User operates an external device, such as a smartphone application, to view displayed emotion estimates and text used for synthesis. User then inputs evaluation information, including correctness of the estimated emotional state, corrections to the emotion label if needed, and comments on appropriateness. User outputs this evaluation information via user interface controls such as buttons, selection lists, and text fields.

### Step 17:

Terminal or external device transmits evaluation information to the server.

Terminal or an external device receives, as input, the evaluation information entered by the user. The device structures the information into a data record including user identifiers, session identifiers, predicted emotion labels, corrected labels, and optional comments. The device serializes this record in a predefined format and applies encryption using a security library. The device sends the encrypted feedback record to the server via a network protocol. The device outputs a feedback message that the server can store and later use for learning.

### Step 18:

Server updates the emotion estimation model based on the evaluation information.

Server receives, as input, the feedback message containing evaluation information. Server associates each feedback item with corresponding stored feature vectors and previously predicted emotion labels. Server aggregates a collection of such feedback items and forms training pairs using the combined feature vectors as inputs and the corrected emotion labels as targets. Server computes a loss function, such as cross-entropy, between current model outputs and corrected labels, and applies a learning algorithm to update model parameters. Server may, based on prior configuration optionally informed by a generative AI model, adjust learning rate schedules or apply noise-mitigation techniques during this update. After completing parameter updates, server outputs an updated emotion estimation model that reflects user-specific feedback and is ready to improve future emotion estimations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Existing speech communication support systems for users with unclear speech or impaired articulation are often limited to converting audio into text or replaying mechanically synthesized speech. Conventional architectures typically perform speech recognition and playback without deeply integrating multimodal emotion estimation, context-aware language generation, and adaptive speech synthesis in a unified processing pipeline. As a result, such systems are unable to generate responses that are tuned to a user's emotional state, and they cannot automatically produce high-quality, structured records of user interactions for longitudinal analysis.

From the perspective of computer technology, conventional systems exhibit several technical shortcomings. First, audio signal processing, speech recognition, emotion estimation, prompt construction for a generative model, and speech synthesis are often implemented as disjoint components. The lack of a tightly coupled control flow across these components leads to increased latency, redundant data transfers, and inconsistent use of intermediate features, such as acoustic feature vectors and recognized text. Second, emotion estimation is typically performed in a generic manner, without systematic personalization based on each user's historical acoustic patterns, resulting in unstable and noisy emotion outputs that are difficult to exploit programmatically. Third, even when a generative AI model is employed, the construction of prompt sentences is usually handcrafted or static, without automatic integration of structured time-series record data, emotional context, and application-specific constraints. This limits the ability of the computing system to automatically generate reliable, context-appropriate responses and analytical reports.

Furthermore, conventional record management in communication support systems tends to store only raw text or raw audio, without managing the dependencies between recognized text, estimated emotion information, generated prompts, model responses, and synthesis parameters. This prevents the system from efficiently reusing prior interaction data for trend analysis, adaptive model behavior, or system optimization. The absence of a systematic mechanism for periodically extracting and aggregating time-series records, formatting them into analysis prompts, and invoking a generative AI model to produce structured analytical outputs results in underutilization of stored data and requires manual effort by human operators.

Accordingly, there is a need for an improved computer-implemented system and server architecture that (i) orchestrates end-to-end processing from acoustic capture, digital signal processing, and speech recognition, through multimodal emotion estimation and prompt sentence generation, to emotion-adaptive text-to-speech synthesis and terminal control, (ii) personalizes emotion estimation using user-specific vocal characteristic information and historical emotion records, and (iii) continuously manages and exploits integrated record information by automatically generating analysis prompt sentences and obtaining analytical result text from a generative AI model. Such an architecture should improve the technical performance of the computing system itself, including more robust emotion estimation, reduced processing latency via coordinated modules, more effective utilization of stored time-series interaction data, and automated generation of context-aware outputs without relying on manual prompt design.

The specific processing by the specific processing unit 290 of the data processing device 12 in Application Example 2 is realized by the following means.

The present invention provides a server comprising at least one processor and at least one memory storing instructions which, when executed by the at least one processor, cause the server to acquire, via a communication interface, acoustic data representing utterance-unit audio captured by a terminal that includes an acoustic sensor, and associated user identification information, device identification information, and time information; to perform speech recognition processing on the utterance-unit acoustic data to generate character string information representing speech content; to extract acoustic feature information from the utterance-unit acoustic data, the acoustic feature information including at least a fundamental frequency, a sound pressure level, spectral information, cepstrum coefficients, and a speaking rate; to generate language feature information from the character string information by natural language processing; to input the acoustic feature information and the language feature information into an emotion estimation model to output emotion information representing an emotional state; to construct a prompt sentence for input to a generative artificial intelligence model based on at least the character string information and the emotion information, and to input the prompt sentence to the generative artificial intelligence model and obtain response text from the generative artificial intelligence model; to determine voice output parameters including at least a speaking rate, a fundamental frequency, a volume, and a voice quality based on at least the response text and the emotion information; to generate synthetic speech data by text-to-speech conversion using the response text and the voice output parameters; to transmit the synthetic speech data to the terminal via the communication interface so that the terminal outputs sound based on the synthetic speech data; and to store, in the at least one memory or in an external storage, the character string information, the emotion information, the prompt sentence, and the response text in association with the time information and the user identification information as record information, and to make the record information available for retrieval, aggregation, and analysis. This enables an integrated computer-implemented pipeline in which speech recognition, multimodal emotion estimation, dynamic prompt sentence generation for a generative AI model, emotion-adaptive speech synthesis, and structured record management are orchestrated by the server, thereby improving the technical functioning of the system through more accurate and personalized emotion inference, efficient reuse of intermediate feature data, automated generation of context-aware responses and analytical reports from accumulated records, and reduced manual intervention in designing and managing prompts for the generative AI model.

The term “acoustic sensor” refers to a sensing element configured to convert air-borne sound waves into an electrical signal, including but not limited to a microphone implemented with an electromechanical or semiconductor structure.

The term “acoustic signal” refers to an electrical signal or data stream that represents sound pressure variations over time, obtained from an acoustic sensor.

The term “acoustic data” refers to digitized data obtained by sampling and quantizing an acoustic signal at a predetermined sampling frequency and bit depth.

The term “digital signal processing” refers to numerical operations applied to acoustic data in the digital domain, including operations such as framing, windowing, spectral analysis, filtering, noise suppression, and feature extraction.

The term “noise-reduced acoustic data” refers to acoustic data that has been processed by a noise suppression algorithm to attenuate background noise components relative to speech components.

The term “speech section” refers to a segment of acoustic data that has been classified as containing user speech, based at least on temporal energy or spectral characteristics.

The term “non-speech section” refers to a segment of acoustic data that has been classified as not containing user speech, including silence or background noise.

The term “utterance-unit acoustic data” refers to a contiguous sequence of speech sections grouped as a single unit corresponding to a user utterance to be processed by recognition and analysis components.

The term “communication interface” refers to hardware and software components that enable data transmission between devices over a communication medium, including wired or wireless network interfaces.

The term “information processing apparatus” refers to a computing device comprising at least one processor and at least one memory, configured to execute programs for processing input data and generating output data.

The term “speech recognition processing” refers to computational processing that converts acoustic data representing speech into character string information representing linguistic content.

The term “character string information” refers to textual data representing the content of a user's utterance, expressed as a sequence of characters or tokens.

The term “acoustic feature information” refers to numerical feature values extracted from acoustic data, including but not limited to fundamental frequency, sound pressure level, spectral characteristics, cepstral coefficients, and speaking rate.

The term “fundamental frequency” refers to an estimated base frequency of a voiced speech segment that corresponds to the perceived pitch of the voice.

The term “sound pressure level” refers to a measure of acoustic energy or intensity over time, typically computed as a root-mean-square or logarithmic value for each time frame.

The term “spectral information” refers to features derived from the frequency-domain representation of acoustic data, including magnitude or power spectra and statistics thereof.

The term “cepstrum coefficients” refers to coefficients obtained by applying a cepstral transform, such as a Mel-frequency cepstral analysis, to spectral information to represent the spectral envelope of speech.

The term “speaking rate” refers to a measure of temporal speed of speech, including metrics such as syllables, phonemes, or words per unit time.

The term “language feature information” refers to numerical feature values derived from character string information by natural language processing, including embeddings or other vector representations of lexical and semantic content.

The term “natural language processing” refers to computational techniques for analyzing and representing human language text, including tokenization, parsing, semantic embedding, and related operations.

The term “emotion information” refers to data representing an estimated emotional state corresponding to a user utterance, including values or labels for one or more emotion categories and associated intensities.

The term “emotion estimation model” refers to a computational model, implemented using a machine learning or rule-based approach, configured to output emotion information from acoustic feature information and language feature information.

The term “prompt sentence” refers to a text sequence constructed as an instruction and context input for a generative artificial intelligence model, including role descriptions, constraints, and content derived from user utterances and emotion information.

The term “generative artificial intelligence model” refers to a trained computational model configured to generate new text outputs in response to input text, including but not limited to large language models.

The term “response text” refers to text generated by a generative artificial intelligence model in response to a prompt sentence.

The term “voice output parameters” refers to control parameters used by a text-to-speech system to determine characteristics of synthesized speech, including at least speaking rate, fundamental frequency, volume, and voice quality.

The term “voice quality” refers to one or more attributes defining the timbral and stylistic characteristics of a synthesized voice, including aspects such as softness, brightness, or speaker persona.

The term “synthetic speech data” refers to digital audio data generated by a text-to-speech system from text input and voice output parameters, suitable for playback as audible speech.

The term “text-to-speech conversion” refers to computational processing that converts text and associated control parameters into synthetic speech data.

The term “terminal” refers to a user-side device comprising at least an acoustic sensor, a communication interface, and an acoustic output element, configured to capture user utterances and to output audio based on received synthetic speech data.

The term “acoustic output element” refers to a device configured to convert electrical audio signals into audible sound, including but not limited to a loudspeaker or an earphone.

The term “record information” refers to structured data stored for each interaction, including at least character string information, emotion information, prompt sentences, response text, time information, and user identification information.

The term “time information” refers to temporal data associated with events in the system, such as timestamps indicating start and end times of user utterances or processing operations.

The term “user identification information” refers to data that uniquely or pseudo-uniquely associates interactions and records with a particular user, including identifiers such as user IDs.

The term “vocal characteristic information” refers to statistical information describing typical acoustic patterns of a user's speech over time, including distributions of volume, pitch, speaking rate, and related features.

The term “general emotion estimation result” refers to emotion information calculated from acoustic feature information and language feature information without applying user-specific corrections.

The term “user-adapted emotion information” refers to emotion information obtained by correcting a general emotion estimation result based on user-specific vocal characteristic information and past emotion information.

The term “analysis prompt sentence” refers to a prompt sentence constructed from accumulated record information over a predetermined period, intended to cause a generative artificial intelligence model to output analysis result text.

The term “analysis result text” refers to text generated by a generative artificial intelligence model in response to an analysis prompt sentence, describing at least a psychological trend of a user and a recommended support policy.

In one embodiment, a system includes a server and one or more terminals. Server and terminal cooperate to implement end-to-end processing from acoustic capture through emotion-adaptive response generation and structured record management.

Terminal includes an acoustic sensor, a signal processing circuit, a communication interface, and an acoustic output element. Terminal includes, as hardware, at least one processor such as a mobile central processing unit and/or a digital signal processor, a memory such as a semiconductor memory, a wireless communication module such as a wireless local area network interface or a short-range wireless interface, and a loudspeaker or earphone. Terminal executes software including an audio input control program, a digital signal processing program, a communication control program, and an audio playback control program under an operating system such as a mobile operating system or an embedded operating system.

Server includes at least one processor such as a general-purpose central processing unit and, optionally, a graphics processing unit for neural network inference, a main memory, a non-volatile storage device such as a magnetic disk or a solid-state drive, and a network interface. Server executes software modules including a speech recognition module, an emotion estimation module, a natural language processing module, a generative AI interface module, a text-to-speech synthesis module, and a record management module. Server may execute these modules as application programs on an application server framework.

Terminal acquires an analog acoustic signal corresponding to a user's utterance through the acoustic sensor, which may be implemented as a directional microelectromechanical microphone element. Terminal converts the analog signal into digital acoustic data using an analog-to-digital converter under control of the audio input control program. Terminal stores the digital acoustic data in a buffer in memory and executes digital signal processing to suppress background noise and to enhance the speech band. Terminal may use a digital signal processing library functionally equivalent to a general-purpose audio processing library, performing windowing, fast Fourier transform, spectral subtraction, and adaptive filtering.

Terminal applies a non-speech removal logic based on short-time energy and zero-crossing rate to identify voice activity. Terminal groups contiguous speech frames into utterance units and attaches user identifiers, device identifiers, and time stamps. Terminal encrypts the resulting data and transmits it to server via a secure transport protocol such as transport layer security over transmission control protocol.

Server receives the transmitted acoustic data and metadata via its network interface and reassembles utterance-unit acoustic data per user session. Server applies speech recognition processing using either a local automatic speech recognition engine built on a deep learning framework or a remote speech recognition service exposed via an application programming interface. Server uses an acoustic model, such as a neural network trained on Mel-frequency cepstral coefficient features, and a language model to convert acoustic data into character string information representing the content of the utterance.

Server then calculates acoustic feature information using a signal processing library such as a library equivalent to a general-purpose audio analysis tool. Server extracts, for each utterance unit, at least a fundamental frequency contour, a sound pressure level trajectory, spectral information, cepstral coefficients such as Mel-frequency cepstral coefficients, and speaking rate estimations derived from voiced segment durations. Server aggregates frame-level measurements into statistical feature vectors, such as mean, variance, and extrema per feature dimension. Server obtains language feature information by inputting the character string information into a natural language encoder model, for example a transformer-based encoder that outputs a dense embedding vector representing semantic and syntactic content.

Server implements the emotion estimation module as a neural network that receives the concatenated acoustic and language feature vectors and outputs emotion information. In one embodiment, server uses a multi-layer neural network or a transformer encoder with multiple attention heads, where input dimensions correspond to acoustic and language features and output dimensions correspond to emotion categories such as anxiety, joy, sadness, anger, loneliness, and calm. Server trains this model offline using supervised learning on labeled utterance data. During training, server uses a loss function such as cross-entropy loss or mean squared error between predicted emotion scores and ground-truth labels, and updates model weights with gradient-based optimization. Server may employ data augmentation techniques such as time-stretching or noise addition on training audio to improve robustness.

Server stores, in a database, vocal characteristic information for each user, such as distributions of average volume, pitch range, and speaking rate computed from historical utterances. During inference, server adjusts general emotion estimation results by applying a correction function that normalizes current acoustic features with respect to user-specific distributions. For example, server may subtract user-specific mean pitch and scale by user-specific standard deviation before feeding features into a final calibration layer, thereby outputting user-adapted emotion information that reflects deviations from the user's personal baseline. This personalization reduces systematic biases and stabilizes emotion outputs. Server constructs a prompt sentence for a generative AI model using the character string information and the user-adapted emotion information. Server executes a prompt construction program that fills a predefined template with dynamic elements. For example, server generates a prompt sentence of the following form:

“You are an AI that supports communication for care staff.

Read the following elderly person's utterance and the estimated emotional state,

and propose three example phrases in polite Japanese that will reassure the elderly person.

### Constraints:

Do not use difficult technical terms.
Keep each sentence short.

Elderly person's utterance: ‘Recently, I feel anxious at night and can't sleep.’

Estimated emotion: Anxiety=0.82, Loneliness=0.40.”

Server transmits this prompt sentence to a generative AI model through the generative AI interface module. The generative AI model may be implemented as a large language model with an autoregressive transformer architecture hosted locally or accessed via an external service. Server sets generation parameters such as maximum output length and randomness parameter values. Server receives response text generated by the generative AI model and stores the response text as part of the session data.

Server then determines voice output parameters based on the emotion information and the type of response. For instance, when the emotion information indicates high anxiety, server lowers the speaking rate and fundamental frequency and selects a calm voice profile. When the emotion information indicates high joy, server may choose a slightly faster speaking rate and a brighter voice quality. Server supplies these parameters, together with the response text, to a text-to-speech module. The text-to-speech module may be a neural text-to-speech system such as a sequence-to-sequence model that converts text into a mel-spectrogram followed by a neural vocoder that synthesizes a waveform.

Server generates synthetic speech data in a digital audio format and transmits the synthetic speech data to terminal via the network interface. Terminal receives this data, decodes it if compressed, and outputs corresponding sound through the acoustic output element. Terminal may dynamically adjust playback volume using its own microphone to measure background noise and to maintain intelligible speech in different environments.

Server stores, in a structured database such as a relational database, record information that includes character string information, user-adapted emotion information, the prompt sentence, the response text, and associated time and user identifiers. Server indexes this record information for efficient retrieval by time, user, and emotion category. Server periodically aggregates record information over a predetermined period, such as one week, for each user. Server generates an analysis prompt sentence that includes multiple utterances and corresponding emotion scores, for example:

“You are an AI that analyzes care records.

From the following one-week conversation records and emotion scores,
summarize this elderly person's psychological trends and points to pay attention to,
in 400-600 characters in Japanese.

Focus especially on changes in night-time anxiety and loneliness.

### [Data]

1. 2026 Jan. 10 20:15 Utterance: ‘I feel a bit scared at night.’ Emotion: Anxiety 0.7, Loneliness 0.5
2. 2026 Jan. 11 10:00 Utterance: ‘I feel good in the morning.’ Emotion: Joy 0.6, Calm 0.7 . . .
. . . (omitted)

Server inputs this analysis prompt sentence to the generative AI model and obtains analysis result text describing trends and recommended support strategies. Server records the analysis result text and provides it to care staff via a user interface.

This architecture improves computer technology in several ways. Server reduces redundant computations by sharing intermediate feature data between emotion estimation and subsequent prompt construction, thereby lowering processing latency and resource consumption compared with separate, uncoordinated modules. Server's personalization mechanism uses stored vocal characteristic information and historical emotion data in a structured way to correct emotion estimates, reducing error rates and yielding more stable outputs. Server's use of structured record information and automated analysis prompt generation enables the generative AI model to operate on rich, time-series data without manual prompt design, improving computational efficiency and consistency of analyses.

Unlike human operators who might craft prompts and interpret emotions on a per-case basis, server applies deterministic preprocessing rules, feature extraction pipelines, and neural network architectures that are specifically tuned to the hardware and communication constraints of the system. For example, server uses fixed-length feature vectors and batch processing for multiple utterances, which allows vectorized operations on modern processors and makes better use of cache and parallelism. Server also employs user-specific normalization and calibration layers in the emotion estimation model that would be impractical to execute manually. These mechanisms constitute more than mere automation of human mental processes; they define non-conventional, computer-centric workflows that achieve lower latency and higher accuracy in emotion-aware interaction.

Server may use different variants of the described architecture. In one variant, server hosts the generative AI model locally on a graphics processing unit, which reduces network round-trip latency and allows tighter integration with internal security and logging systems. In another variant, server uses a compressed or distilled version of the emotion estimation model for deployment on lower-power hardware, trading off some model complexity for faster inference. In yet another variant, server partitions processing such that a subset of acoustic feature extraction is executed on terminal to reduce uplink bandwidth, while higher-level modeling remains on server.

Server and terminal thereby cooperate to realize a system that is tightly coupled to physical devices and signals: microphone capture, network communication, and loudspeaker output. The combination of specified data structures, including utterance-unit acoustic data, feature vectors, prompt sentences, and record information, with defined neural network architectures and deterministic preprocessing, results in technical effects such as improved speech emotion estimation precision, reduced communication load via utterance-unit transmission and noise suppression, and efficient generation and reuse of analytical outputs from accumulated interaction data.

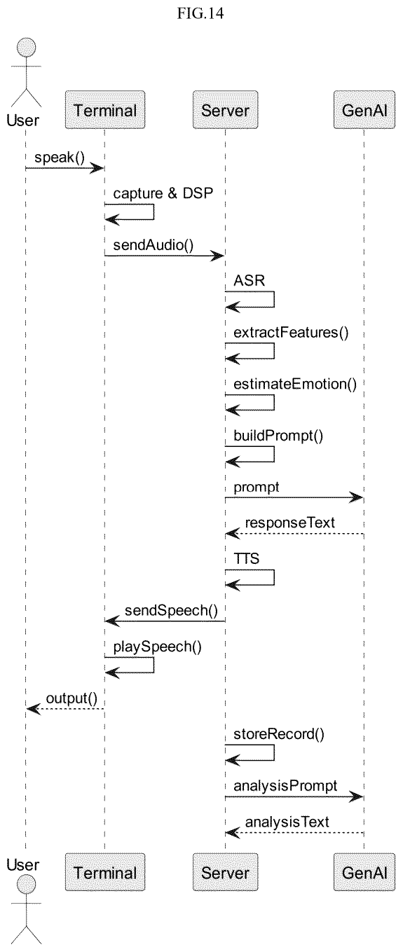

The following describes the processing flow using FIG. 14.

### Step 1:

User wears or carries the terminal and produces speech.

User utters a natural sentence, for example, “Recently, I feel anxious at night and can't sleep,” without operating any special controls.

Input: Air-borne sound waves generated by the user's voice.

Output: Acoustic pressure variations in the vicinity of the terminal's acoustic sensor.

### Step 2:

Terminal captures the utterance and converts it into digital acoustic data.

Terminal uses the acoustic sensor to convert the sound waves into an analog electrical signal and uses an analog-to-digital converter to sample the signal at a fixed sampling rate (for example, 16 kHz) and quantization bit depth (for example, 16 bits). Terminal executes an audio input control program on its processor to write the resulting pulse-code-modulated samples into a circular buffer in main memory.

Input: Analog electrical signal from the acoustic sensor.

Output: Raw digital acoustic data as a sequence of PCM samples stored in memory.

### Step 3:

Terminal applies noise suppression and basic digital signal processing.

Terminal divides the PCM samples into overlapping frames (for example, 25 ms frames with 10 ms shift) and multiplies each frame by a window function. Terminal computes a fast Fourier transform for each frame to obtain a short-time spectrum and estimates a noise spectrum from low-energy frames. Terminal subtracts or attenuates the estimated noise spectrum from each frame's magnitude spectrum and reconstructs a time-domain waveform using an inverse transform and overlap-add. Terminal thereby produces noise-reduced acoustic data with speech components emphasized over background noise.

Input: Raw digital acoustic data.

Output: Noise-reduced digital acoustic data with suppressed background noise.

### Step 4:

Terminal detects speech activity and segments utterance-unit acoustic data.

Terminal calculates, for each frame of the noise-reduced acoustic data, short-time energy and zero-crossing rate. Terminal compares these values with predefined thresholds to label frames as speech or non-speech. Terminal merges consecutive speech frames into segments and removes leading and trailing non-speech regions. Terminal marks each contiguous speech segment as an utterance unit and records start and end time indices.

Input: Noise-reduced digital acoustic data.

Output: One or more utterance-unit acoustic data segments with associated time indices.

### Step 5:

Terminal packages utterance data with metadata and transmits it to server.

Terminal attaches user identification information, device identification information, timestamps, and session identifiers to each utterance-unit segment. Terminal encrypts the combined payload using a secure protocol and sends packets to server via a wireless communication interface such as a wireless local area network or a short-range wireless link. Terminal manages a transmission queue and retransmits packets if acknowledgements are not received within a timeout.

Input: Utterance-unit acoustic data segments and associated metadata.

Output: Encrypted data packets carrying utterance-unit acoustic data transmitted over the network to server.

### Step 6:

Server receives packets and reconstructs per-session utterance data.

Server uses its network interface to receive incoming encrypted packets and a communication module to decrypt them. Server validates packet sequence numbers and aggregates payloads belonging to the same utterance and session. Server concatenates the received acoustic data segments in time order, reconstructing complete utterance-unit acoustic data, and stores them in a session buffer in main memory together with user identifiers and timestamps.

Input: Encrypted data packets containing utterance-unit acoustic data and metadata.

Output: Decrypted, ordered utterance-unit acoustic data associated with a user session.

### Step 7:

Server performs automatic speech recognition on each utterance.

Server passes each utterance-unit acoustic data buffer to a speech recognition engine. Server uses an acoustic feature extractor to compute features such as Mel-frequency cepstral coefficients and feeds them into an acoustic model implemented as a neural network. Server applies a decoding algorithm with a language model to map sequences of acoustic observations to likely character or word sequences. Server outputs character string information representing the content of the user's utterance along with confidence scores.

Input: Utterance-unit acoustic data associated with a session.

Output: Character string information representing recognized speech content and optional recognition confidence data.

### Step 8:

Server computes acoustic feature information for emotion estimation.

Server uses a signal processing library to analyze each utterance-unit acoustic data buffer. Server extracts frame-level features such as fundamental frequency, sound pressure level, spectral centroid, Mel-frequency cepstral coefficients, and voiced versus unvoiced status. Server aggregates these into a fixed-length acoustic feature vector per utterance by computing statistics such as mean, variance, minimum, and maximum.

Input: Utterance-unit acoustic data.

Output: Acoustic feature information in the form of a numerical feature vector for each utterance.

### Step 9:

Server generates language feature information from recognized text.

Server tokenizes the character string information and encodes it using a natural language encoder model, such as a transformer-based text encoder. Server maps the text into a dense vector representation that captures semantic and syntactic relations. Server may apply pooling operations over token embeddings to obtain a single language feature vector per utterance.

Input: Character string information representing speech content.

Output: Language feature information as a dense embedding vector for each utterance.

### Step 10:

Server estimates emotion information using multimodal features.

Server concatenates the acoustic feature vector and the language feature vector into a single input vector. Server feeds this vector into an emotion estimation model implemented as a neural network with multiple layers, such as fully connected layers with non-linear activation functions and, optionally, attention mechanisms. Server computes output scores for predefined emotion categories by applying a softmax or other activation to the final layer. Server then retrieves user-specific vocal characteristic information and historical emotion records from a database and normalizes the raw scores using user-specific parameters, for example by subtracting user-specific means and scaling by standard deviations. Server thus outputs user-adapted emotion information that includes per-category scores and a primary emotion label.

Input: Acoustic feature information, language feature information, and user-specific vocal characteristic information.

Output: User-adapted emotion information representing estimated emotional state per utterance.

### Step 11:

Server constructs a prompt sentence for a generative AI model.

Server processes the character string information and the user-adapted emotion information through a prompt construction module. Server selects a template according to a scenario, such as generating suggested phrases for care staff, and fills in variable fields with the recognized utterance and emotion scores. Server produces a prompt sentence text that includes a role description, task instructions, constraints, and the specific utterance and emotion values. For example, server may generate:

“You are an AI that supports communication for care staff.

Read the following elderly person's utterance and the estimated emotional state,
and propose three example phrases in polite Japanese that will reassure the elderly person.

### Constraints:

Do not use difficult technical terms.
Keep each sentence short.

Elderly person's utterance: ‘Recently, I feel anxious at night and can't sleep.’

Estimated emotion: Anxiety=0.82, Loneliness=0.40.”

Input: Character string information and user-adapted emotion information.

Output: Prompt sentence text prepared for the generative AI model.

### Step 12:

Server sends the prompt sentence to the generative AI model and obtains response text.

Server issues an API request or local inference call to a generative AI model using the prompt sentence as input. Server sets generation parameters such as maximum output length and randomness level and invokes the model's text generation function. Server receives one or more candidate outputs from the model and optionally filters them for constraint violations, such as length constraints or prohibited expressions. Server selects the final response text to be used for subsequent synthesis and recording.

Input: Prompt sentence text.

Output: Response text generated by the generative AI model.

### Step 13:

Server determines voice output parameters and synthesizes speech.

Server analyzes the user-adapted emotion information to decide appropriate voice output parameters. Server maps high anxiety scores to slower speaking rates and lower pitch, and maps calm or positive emotions to neutral or slightly faster speaking rates and moderate pitch. Server combines these parameters with a selected voice profile and passes them, together with the response text, to a text-to-speech synthesis engine. Server runs the engine to convert text into a mel-spectrogram and then into waveform samples using a neural vocoder, thereby generating synthetic speech data.

Input: Response text and user-adapted emotion information.

Output: Synthetic speech data and associated voice output parameters.

### Step 14:

Server transmits synthetic speech data to terminal.

Server packages the synthetic speech data and relevant playback metadata, such as priority and timing, into data packets. Server sends the packets to terminal via a secure communication channel. Server may choose a streaming mode, in which audio is divided into segments that can be played as soon as they arrive, or a buffered mode, in which the entire audio file is sent before playback starts.

Input: Synthetic speech data and playback metadata.

Output: Network packets carrying synthetic speech data delivered to terminal.

### Step 15:

Terminal receives and plays back the synthetic speech.

Terminal uses its communication interface to receive the data packets and a communication control program to decrypt and reassemble them into a continuous audio stream. Terminal decodes the audio if it is compressed and loads it into a playback buffer. Terminal measures ambient noise using its microphone and adjusts playback volume within a safe range. Terminal sends the digital samples to a digital-to-analog converter and drives the acoustic output element so that the user and surrounding persons hear the synthesized response.

Input: Synthetic speech data and playback metadata received from server.

Output: Audible sound corresponding to the generated response played through the acoustic output element.

### Step 16:

Server stores integrated record information in a database.

Server assembles a record structure including at least the character string information, user-adapted emotion information, the prompt sentence, the response text, timestamps, user identification, and optional synthesis parameters. Server inserts this structure into a database table indexed by user and time, enabling later retrieval and aggregation. Server may also store references to raw acoustic data or derived features for future model retraining.

Input: Character string information, user-adapted emotion information, prompt sentence, response text, and associated metadata.

Output: Persistent record entries stored in a structured database for subsequent search and analysis.

### Step 17:

Server generates periodic analysis prompts and obtains analytical reports.

Server periodically queries the database to retrieve record information over a configurable time window for each user. Server formats selected utterances and emotion scores into a structured text block and constructs an analysis prompt sentence instructing the generative AI model to summarize psychological trends and care points. Server sends this analysis prompt sentence to the generative AI model and receives analysis result text, which server then stores and makes available to care staff as a report.

Input: Time-series record information for a selected period.

Output: Analysis prompt sentence and corresponding analysis result text summarizing user trends.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

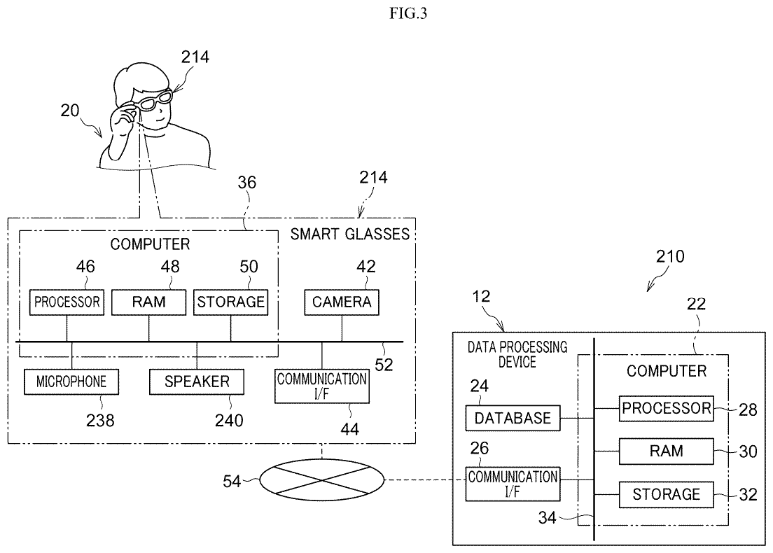

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

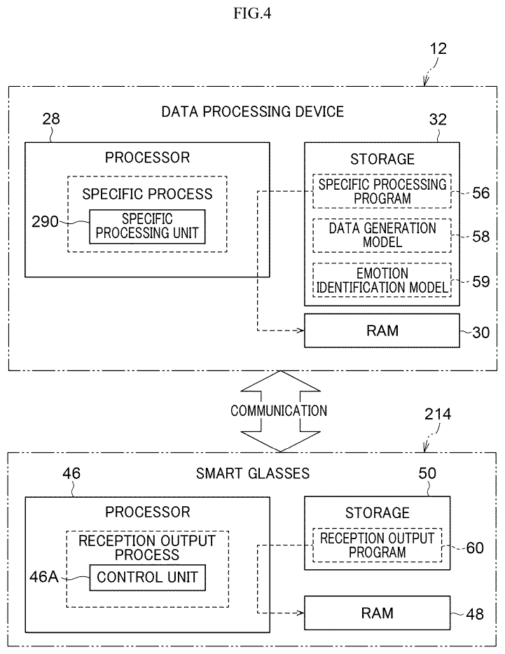

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result.” The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

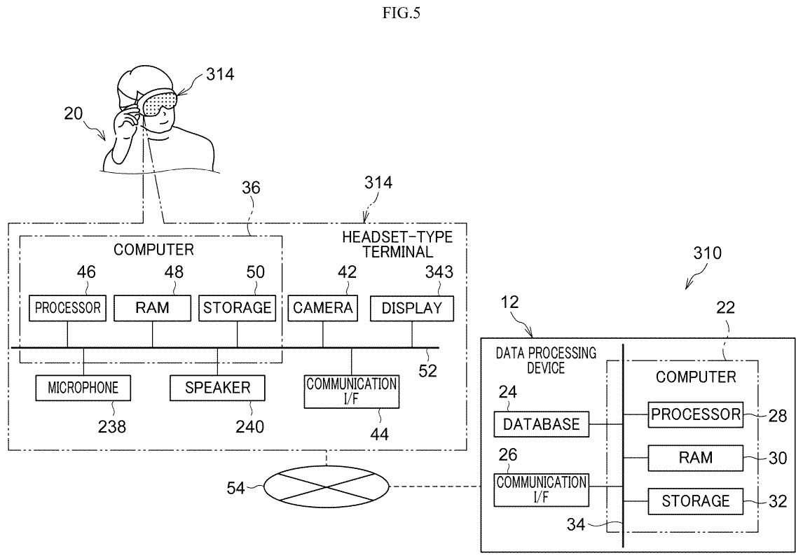

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

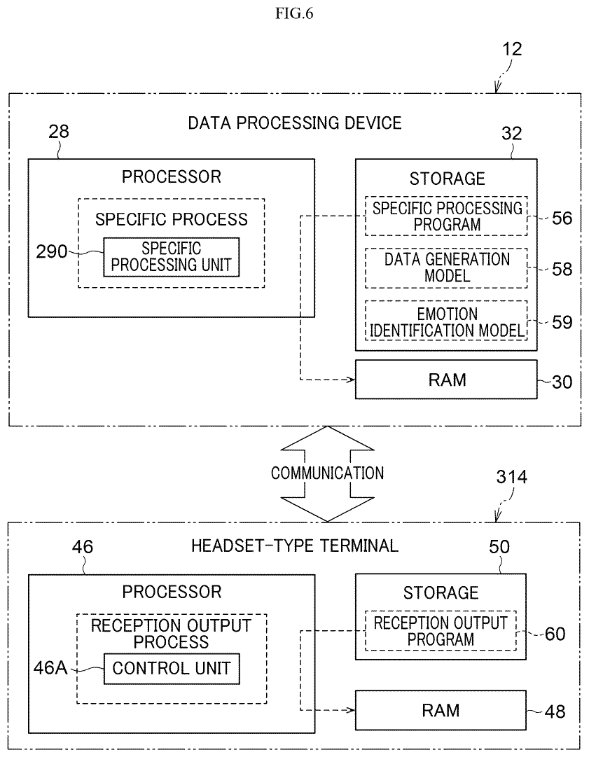

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI).

Examples of the data generation model 58 include generative Als such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

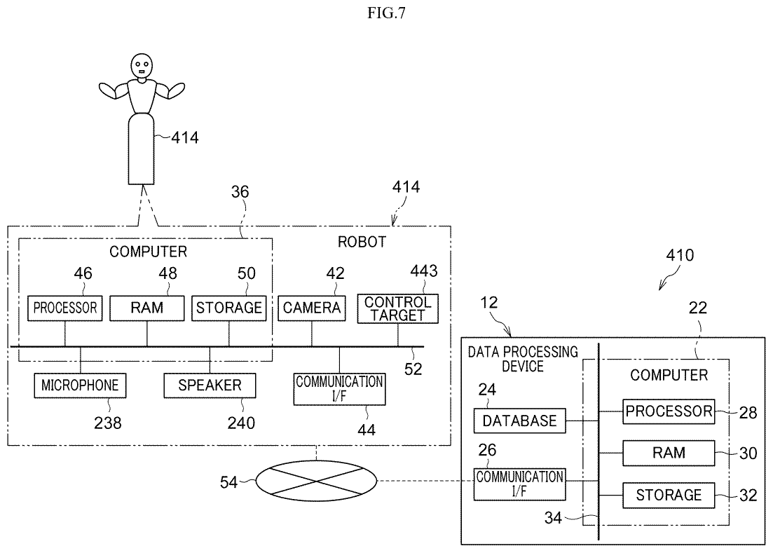

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

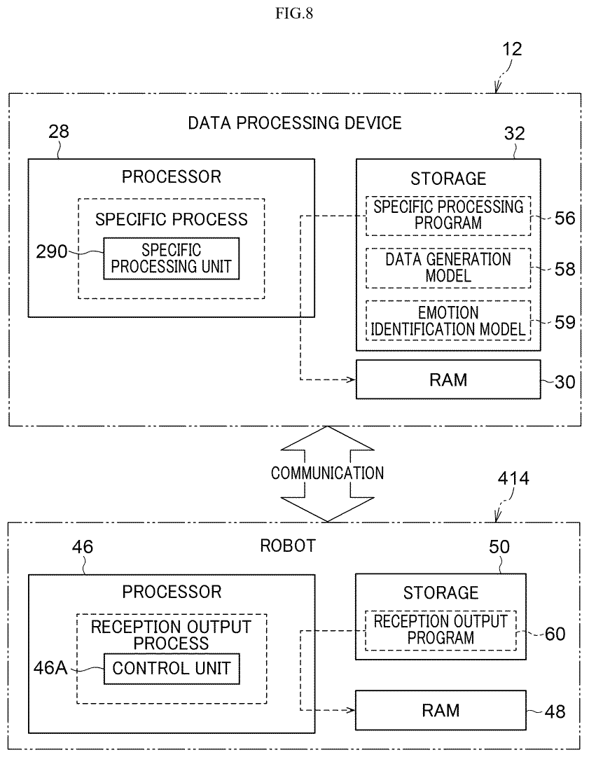

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI).

Examples of the data generation model 58 include generative Als such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

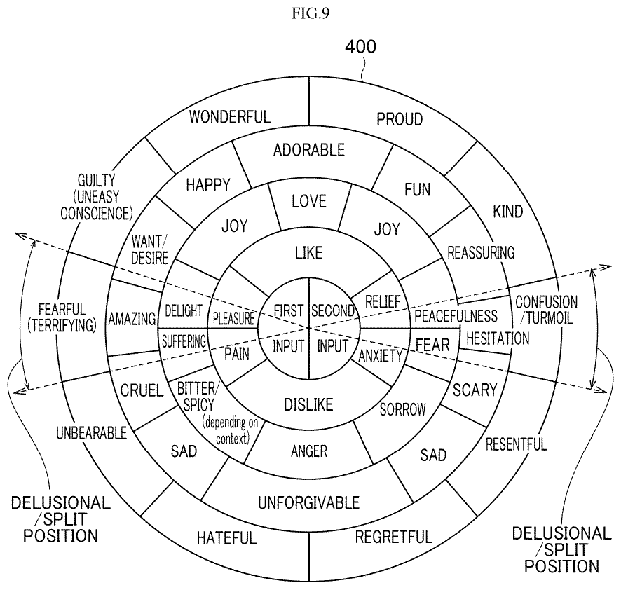

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

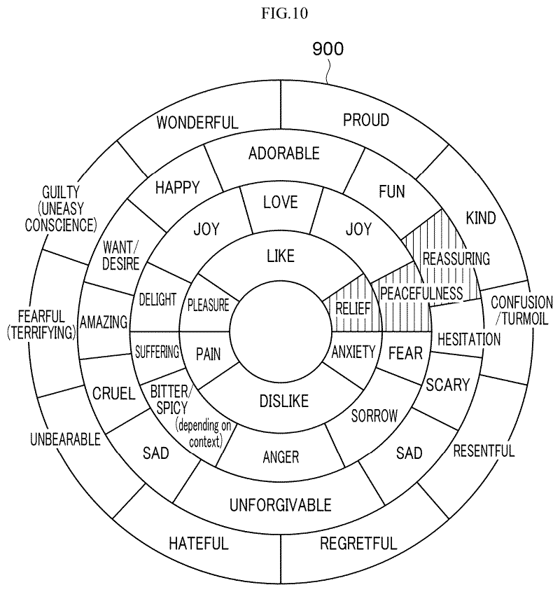

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire an acoustic signal corresponding to a user utterance in real time using an acoustic sensor unit,
perform signal processing on the acoustic signal, the signal processing including noise suppression processing, frequency characteristic enhancement processing, and dynamic range correction processing, to generate a processed speech signal in which a feature of the user utterance is emphasized,
convert the processed speech signal into time-series feature data and perform speech recognition processing using a deep learning model based on the time-series feature data, the speech recognition processing being adapted for each user, convert a content of the user utterance into a character string, and correct the character string and perform phrase replacement based on stored utterance history information and frequent-expression information associated with the user,
generate prosody control information including prosodic information for the corrected character string, and perform speech synthesis processing to generate a synthesized speech signal based on the prosody control information and voice output attributes set for each user,
supply the synthesized speech signal to an acoustic output apparatus and output the synthesized speech signal to an outside,
transmit inquiry information including a prompt sentence to a generative information processing model in order to improve at least a model or a parameter used for the speech recognition processing or the speech synthesis processing, and update setting information relating to at least an adaptation method of the speech recognition processing or a control method of the speech synthesis processing based on response information acquired from the generative information processing model, and
transmit and receive data including at least the acoustic signal and the synthesized speech signal via a wireless transmission path in accordance with an environmental condition of the user and a communication state.

### (Supplementary 2)

The system according to supplementary 1,
wherein the processor is configured to
estimate a noise spectrum based on an environmental noise section, execute noise suppression processing in a frequency domain using the estimated noise spectrum, execute band characteristic correction processing that emphasizes a frequency band having high speech intelligibility, and execute dynamic range compression processing that suppresses variation of a volume level in real time, in the signal processing to generate the processed speech signal in which the feature of the user utterance is emphasized.

### (Supplementary 3)

The system according to supplementary 1,
wherein the processor is configured to
generate the prompt sentence including meta-information relating to at least a speech characteristic of the user, a usage environment, and a recognition error history, transmit the prompt sentence as the inquiry information to the generative information processing model, and automatically reset at least one of an adaptation policy of a speech recognition model for each user, a registration policy of frequent expressions, and prosody control parameters in the speech synthesis based on the response information acquired from the generative information processing model.

### Application Example 1

### (Supplementary 1)

A system comprising a processor,
wherein the processor is configured to
acquire, in real time, a voice utterance of a user as an audio signal by controlling an acoustic input unit,
analyze the audio signal in a time domain and a frequency domain, estimate a noise component, and execute noise reduction and speech enhancement of the audio signal by spectral subtraction or filtering so as to generate an enhanced audio signal,
segment the enhanced audio signal into frames of a predetermined frame length and shift length, extract an acoustic feature sequence from the frames, and convert the acoustic feature sequence into character string data by inputting the acoustic feature sequence to a speech recognition model based on deep learning and updating a recognition result on the basis of speaker characteristic information and vocabulary information for each user,
normalize the character string data and perform linguistic unit segmentation so as to generate a linguistic feature sequence for speech synthesis, and generate an audio waveform by inputting the linguistic feature sequence to a statistical or neural network speech synthesis model and adjusting prosody, speaking rate, and pitch on the basis of preference information of the user,
control an acoustic output unit so as to reproduce the generated audio waveform and control an output volume and a frequency characteristic in accordance with an ambient sound level,
control a terminal apparatus including the acoustic input unit and the acoustic output unit and an information processing apparatus including the speech recognition model and the speech synthesis model so as to mutually transmit and receive the enhanced audio signal and the generated audio waveform in an encrypted manner via a communication unit,
store the character string data and the speaker characteristic information for each user in a storage medium, manage the stored character string data as care record information, and update parameters of the speech recognition model and the speech synthesis model by using the speaker characteristic information, and
transmit inquiry data including a prompt sentence relating to customization of the speech recognition model or the speech synthesis model or relating to creation of a dialogue template to an external generative artificial intelligence model, obtain response data from the generative artificial intelligence model, and update, on the basis of the response data, at least one of the speaker characteristic information, the vocabulary information, and text template information.

### (Supplementary 2)

The system according to supplementary 1,
wherein the processor is configured to perform voice activity detection to discriminate a voice section and a non-voice section in the audio signal, estimate a noise spectrum in the non-voice section, remove a noise component from a spectrum of the audio signal in the voice section by using the noise spectrum, and control a gain of a predetermined frequency band so as to improve speech intelligibility.

### (Supplementary 3)

The system according to supplementary 1,
wherein the processor is configured to generate speaker adaptation parameters and vocabulary bias parameters on the basis of the character string data and acoustic feature information accumulated in the storage medium for each user, and apply the speaker adaptation parameters and the vocabulary bias parameters to an acoustic model and a language model used in the speech recognition model so as to execute speech recognition processing adapted to utterance characteristics and frequently used expressions of the user.

### Example 2

### (Supplementary 1)

A system comprising a processor,
wherein the processor is configured to
acquire a user utterance as an audio signal by a sound collection unit,
perform signal processing including noise reduction, frequency characteristic correction, and volume normalization on the audio signal acquired by the sound collection unit to generate preprocessed audio data suitable for speech recognition,
generate string data based on the preprocessed audio data by using a machine learning model as a speech recognition unit,
calculate audio feature quantities and text feature quantities from the preprocessed audio data and the string data generated by the speech recognition unit, and estimate an emotional state of the user based on the audio feature quantities and the text feature quantities as an emotion estimation unit,
construct, as a prompt sentence in a natural language, information including the string data generated by the speech recognition unit and the emotional state estimated by the emotion estimation unit, input the prompt sentence to a generative artificial intelligence model, and obtain, from the generative artificial intelligence model, a text adjustment candidate that has a meaning equivalent or similar to that of the string data while having adjusted style, politeness, and expression strength as a text adjustment unit,
determine whether the text adjustment candidate obtained by the text adjustment unit includes an inappropriate expression, an offensive expression, or an expression unsuitable for a usage scene, and, based on a result of the determination, adopt one of the text adjustment candidate and the string data as text for speech synthesis as a safety determination unit,
determine prosody control parameters for controlling at least one of speaking rate, fundamental frequency, volume, and intonation in accordance with scene information indicating a usage scene and the emotional state estimated by the emotion estimation unit, and generate an audio signal based on the text for speech synthesis adopted by the safety determination unit and the prosody control parameters as a speech synthesis unit,
transmit the audio signal generated by the speech synthesis unit to a terminal device as a communication unit,
cause the terminal device to output the audio signal received from the communication unit from an acoustic output device as an audio output unit,
acquire evaluation information from the user regarding an estimation result of the emotion estimation unit and appropriateness of audio output by the speech synthesis unit as an evaluation information acquisition unit, and
update parameters of the machine learning model in the emotion estimation unit based on the evaluation information acquired by the evaluation information acquisition unit to improve estimation accuracy of the emotional state as a learning unit.

### (Supplementary 2)

The system according to supplementary 1,
wherein the processor is configured to
input, by the text adjustment unit, a prompt sentence to the generative artificial intelligence model so as to cause the generative artificial intelligence model to propose numerical parameter values of recommended settings of the speaking rate, the fundamental frequency, the volume, and the intonation corresponding to an emotion category and the usage scene, and construct prosody control rules defining the prosody control parameters based on the proposed numerical parameter values output from the generative artificial intelligence model.

### (Supplementary 3)

The system according to supplementary 1,
wherein the processor is configured to
input, by the learning unit, a prompt sentence describing a structure of feedback data acquired by the evaluation information acquisition unit and a possibility that the feedback data includes noise to the generative artificial intelligence model, and set update conditions or hyperparameters of the machine learning model of the emotion estimation unit based on proposals regarding an online learning algorithm, a noise label mitigation method, and a learning rate scheduling strategy that are output from the generative artificial intelligence model.

### Application Example 2

### (Supplementary 1)

A system comprising a processor and a memory,
wherein the processor is configured to
acquire an acoustic signal representing a user's utterance by controlling an acoustic sensor, and sample and quantize the acoustic signal to obtain acoustic data; and
perform digital signal processing on the acoustic data, including frequency analysis and noise suppression processing, to generate noise-reduced acoustic data; and
classify frames of the noise-reduced acoustic data into speech sections and non-speech sections based on at least short-time energy and frequency characteristics, and extract speech sections as utterance-unit acoustic data; and
transmit the utterance-unit acoustic data, together with user identification information, device identification information, and time information, to an information processing apparatus via a communication interface; and
cause the information processing apparatus to perform speech recognition processing on the utterance-unit acoustic data to generate character string information representing speech content; and
cause the information processing apparatus to extract, from the utterance-unit acoustic data, acoustic feature information including at least a fundamental frequency, a sound pressure level, spectral information, cepstrum coefficients, and a speaking rate, and to generate language feature information from the character string information by natural language processing, and to output emotion information representing an emotional state based on the acoustic feature information and the language feature information; and
cause the information processing apparatus to construct a prompt sentence for input to a generative artificial intelligence model, based on the character string information and the emotion information, and to input the prompt sentence to the generative artificial intelligence model and obtain response text from the generative artificial intelligence model; and
cause the information processing apparatus to determine voice output parameters including at least a speaking rate, a fundamental frequency, a volume, and a voice quality, based on the response text and the emotion information, and to generate synthetic speech data by text-to-speech conversion using the response text and the voice output parameters; and
cause the information processing apparatus to transmit the synthetic speech data to a terminal including the acoustic sensor, via the communication interface, and to control the terminal so that an acoustic output element outputs sound based on the synthetic speech data; and
store, in the memory or in an external storage, the character string information, the emotion information, the prompt sentence, and the response text in association with the time information and the user identification information as record information, and make the record information available for retrieval, aggregation, and analysis.

### (Supplementary 2)

The system according to supplementary 1,
wherein the processor is configured to
refer to vocal characteristic information statistically calculated for each user and past emotion information accumulated for each user, and correct a general emotion estimation result based on the acoustic feature information and the language feature information, so as to output user-adapted emotion information as the emotion information.

### (Supplementary 3)

The system according to supplementary 1,
wherein the processor is configured to
extract the record information accumulated over a predetermined period, generate an analysis prompt sentence including the extracted record information, input the analysis prompt sentence to the generative artificial intelligence model, obtain analysis result text representing at least a psychological trend of the user and a support policy from the generative artificial intelligence model, and store the analysis result text in association with the user identification information.

What is claimed is:

1. A system comprising:
circuitry configured to:
receive, via a communication interface coupled to a packet-switched network, audio data representing an utterance of a user captured by an acoustic sensor of a terminal device;
perform digital signal processing on the audio data to generate a processed speech signal in which features of the utterance are emphasized;
convert the processed speech signal into time-series feature data and perform speech recognition using a deep learning model based on the time-series feature data to generate a character string representing content of the utterance;
generate a synthesized speech signal based on the character string using a speech synthesis model;
transmit the synthesized speech signal to the terminal device via the communication interface for acoustic output; and
transmit a prompt data structure to a generative neural network model and update a parameter of at least one of the deep learning model and the speech synthesis model based on response data received from the generative neural network model.

2. The system according to claim 1, wherein the digital signal processing includes noise suppression processing in a frequency domain using an estimated noise spectrum, frequency characteristic enhancement processing that emphasizes a frequency band associated with speech intelligibility, and dynamic range correction processing that suppresses variation of a volume level.

3. The system according to claim 2, wherein the noise suppression processing includes performing a short-time Fourier transform on windowed frames of the audio data, estimating the noise spectrum from frames classified as non-speech by a voice activity detector, and attenuating the estimated noise spectrum from a magnitude spectrum of each frame.

4. The system according to claim 1, wherein converting the processed speech signal into the time-series feature data includes computing a magnitude spectrogram, applying a set of mel-scaled filter banks to generate mel-frequency filter bank energies, and normalizing feature vectors using per-user mean and variance statistics.

5. The system according to claim 1, wherein the deep learning model comprises an encoder including a plurality of self-attention layers and feed-forward layers, and a decoder configured to generate probability distributions over output tokens, and wherein the circuitry performs beam search decoding using the probability distributions and a language model to generate the character string.

6. The system according to claim 1, wherein the circuitry is further configured to correct the character string by comparing subsequences of the character string with frequent-expression information associated with the user, and replacing a subsequence having a confidence score below a threshold with a matching frequent expression when an edit distance between the subsequence and the matching frequent expression is below a predetermined value.

7. The system according to claim 1, wherein the circuitry is further configured to adapt the deep learning model for the user by applying speaker adaptation parameters including at least one of a speaker embedding vector, a linear transformation layer inserted into the deep learning model, and vocabulary bias parameters that adjust probability distributions over user-specific terms during decoding.

8. The system according to claim 7, wherein the circuitry updates the speaker adaptation parameters by computing gradients of a loss function with respect to the speaker adaptation parameters using accumulated recognition results and applying an optimization algorithm to update the speaker adaptation parameters while maintaining a shared base model.

9. The system according to claim 1, wherein the speech synthesis model includes a neural acoustic model that converts a phoneme sequence and prosody control vectors into a mel-spectrogram, and a neural vocoder model that converts the mel-spectrogram into a time-domain waveform.

10. The system according to claim 9, wherein the circuitry is further configured to generate the prosody control vectors by predicting, for each linguistic unit of the character string, a pitch contour, a duration, and an emphasis pattern using a prosody prediction model, and adjusting the prosody control vectors based on voice output attributes associated with the user including at least one of a speaking rate, a pitch range, and a prosodic style.

11. The system according to claim 1, wherein the circuitry is further configured to normalize the character string by converting variant character forms to standard forms, expanding abbreviations, and performing linguistic unit segmentation to generate a linguistic feature sequence including phoneme symbols and prosodic labels as input to the speech synthesis model.

12. The system according to claim 1, wherein the prompt data structure includes meta-information relating to at least speech characteristics of the user, an acoustic environment of the terminal device, and a recognition error history, and wherein the circuitry updates, based on the response data, configuration information including at least one of an adaptation policy of the deep learning model, a registration policy of frequent expressions, and prosody control parameters of the speech synthesis model.

13. The system according to claim 12, wherein the circuitry parses the response data to extract numerical parameter values, validates the numerical parameter values against predefined constraints, and writes approved values into configuration data structures controlling at least one of adaptation learning rates, phrase replacement thresholds, and prosody parameter ranges.

14. The system according to claim 1, wherein the circuitry is further configured to:
calculate audio feature quantities from the processed speech signal and text feature quantities from the character string; and
estimate an emotional state of the user based on the audio feature quantities and the text feature quantities using an emotion estimation model.

15. The system according to claim 14, wherein the circuitry is further configured to construct the prompt data structure to include the character string and the estimated emotional state, transmit the prompt data structure to the generative neural network model, and receive from the generative neural network model a text adjustment candidate having adjusted style, politeness, or expression strength relative to the character string while preserving semantic content.

16. The system according to claim 14, wherein the circuitry is further configured to determine prosody control parameters for the speech synthesis model based on the estimated emotional state and scene information indicating a usage context, and to acquire evaluation information from the user regarding the estimated emotional state and update parameters of the emotion estimation model based on the evaluation information.

17. The system according to claim 1, wherein the terminal device performs the digital signal processing locally on the audio data before transmitting the processed speech signal to the circuitry via the communication interface, and wherein the terminal device encodes the processed speech signal using an audio codec and transmits encoded frames as encrypted packets including sequence numbers and timestamps over the packet-switched network.

18. A system comprising:
a communication interface including a network interface controller coupled to a packet-switched network and configured to transmit and receive data packets;
a memory storing instructions, a deep learning speech recognition model comprising a plurality of self-attention layers and feed-forward layers, a neural network speech synthesis model comprising a neural acoustic model and a neural vocoder, and a generative neural network model; and
circuitry comprising one or more processors coupled to the memory and configured to execute the instructions to:
receive, via the communication interface, audio data representing an utterance of a user captured by an acoustic sensor of a terminal device coupled to the packet-switched network;
perform digital signal processing on the audio data including noise suppression in a frequency domain, frequency band emphasis, and dynamic range correction to generate a processed speech signal;
convert the processed speech signal into time-series feature data including mel-frequency feature vectors normalized using per-user statistics, and input the time-series feature data to the deep learning speech recognition model to generate a character string representing content of the utterance;
correct the character string by performing phrase replacement based on utterance history information and frequent-expression information associated with the user;
generate prosody control information for the corrected character string and input the prosody control information and voice output attributes associated with the user to the neural network speech synthesis model to generate a synthesized speech signal;
transmit the synthesized speech signal to the terminal device via the communication interface for acoustic output; and
construct a prompt data structure including meta-information relating to at least speech characteristics of the user, an acoustic environment of the terminal device, and a recognition error history, transmit the prompt data structure to the generative neural network model, receive response data, and update a configuration parameter of at least one of the deep learning speech recognition model and the neural network speech synthesis model based on the response data.

19. The system according to claim 18, wherein the circuitry is further configured to store the character string, the prosody control information, and the configuration parameter in a storage device coupled to the packet-switched network as a structured record associated with a timestamp and a user identifier.

20. A method performed by circuitry of a server coupled to a packet-switched network via a communication interface, the method comprising:
receiving, via the communication interface, audio data representing an utterance of a user captured by an acoustic sensor of a terminal device;
performing digital signal processing on the audio data to generate a processed speech signal in which features of the utterance are emphasized;
converting the processed speech signal into time-series feature data and performing speech recognition using a deep learning model based on the time-series feature data to generate a character string representing content of the utterance;
generating a synthesized speech signal based on the character string using a speech synthesis model;
transmitting the synthesized speech signal to the terminal device via the communication interface for acoustic output; and
transmitting a prompt data structure to a generative neural network model and updating a parameter of at least one of the deep learning model and the speech synthesis model based on response data received from the generative neural network model.
